(19) United States
(12) Patent Application Publication
(10) Pub. No.: US 2024/0430980 A1
(43) Pub. Date: Dec. 26, 2024

(54) MANAGING RECEPTION OF MULTICAST AND/OR BROADCAST SERVICES AFTER A STATE TRANSITION

(71) Applicant: GOOGLE LLC, Mountain View, CA (US)

(72) Inventors: Chih-Hsiang Wu, Taoyuan City (CN); Teming Chen, Taoyuan City (CN)

(21) Appl. No.: 18/703,051

(22) PCT Filed: Oct. 21, 2022
(86) PCT No.: PCT/US22/47422

§ 371 Date: Apr. 19, 2024

Related U.S. Application Data
(60) Provisional application No. 63/270,188, filed on Oct. 21, 2021.

(51) Int. Cl. H04W 76/40; H04W 76/27

(52) U.S. Cl. CPC H04W 76/40; H04W 76/27

(57) ABSTRACT

In a method of managing multicast and/or broadcast services (MBS) communications after a state transition, a UE receives MBS data from a RAN using MBS configuration parameters while the UE is in a connected state with the RAN. The CE transitions from the connected state to an idle state or an inactive state. While the UE is in the idle state or the inactive state, and based on whether the MBS configuration parameters are for receiving a broadcast MBS session or a non-broadcast MBS session, the UE either continues or does not continue, respectively, to receive MBS data using the MBS configuration parameters.

### FIELD OF THE DISCLOSURE

This disclosure relates to wireless communications and, more particularly, to managing configuration parameters for multicast and/or broadcast service(s) (MBS) and reception of MBS after a state transition.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, or an Internet Control Message Protocol (ICMP) layer. Generally, the UE and a base station can use SRBs to exchange RRC messages as well as non-access stratum (NAS) messages, and can use DRBs to transport data on a user plane.

The RRC sublayer specifies the RRC_IDLE state, in which a UE does not have an active radio connection with a base station; the RRC_CONNECTED state, in which the UE has an active radio connection with the base station; and the RRC_INACTIVE state that allows the UE to more quickly transition back to the RRC_CONNECTED state due to Radio Access Network (RAN)-level base station coordination and RAN paging procedures.

In some scenarios, a UE can operate in a state in which a radio resource control connection with the RAN is not active (e.g., RRC_IDLE or RRC_INACTIVE state) and subsequently transition to the connected state. Generally, in the inactive state, the radio connection between the UE and the RAN is suspended. Later, when the UE is triggered to send data (e.g., outgoing phone call, browser launch) or receives a paging message from the base station, the UE can then transition to the connected state. To carry out the transition, the UE can request that the base station establish a radio connection (e.g., by sending an RRC Setup Request message to the base station) or resume the suspended radio connection (e.g., by sending an RRC Resume Request message to the base station), so that the base station can configure the UE to operate in the connected state.

In some cases, the UE in the RRC_IDLE or RRC_INACTIVE state has only one packet (or only relatively small packets) to transmit, or the base station has only one packet (or only relatively small packets) to transmit to the UE operating in the RRC_IDLE or RRC_INACTIVE state. In these cases, the UE in the RRC_IDLE or RRC_INACTIVE state can perform an early data communication without transitioning to the RRC_CONNECTED state, e.g., by using techniques as specified in 3GPP specification 36.300 v16.4.0 sections 7.3a-7.3d.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, UEs support a 100 MHz bandwidth in frequency range 1 (FR1) and a 400 MHz bandwidth in frequency range (FR2). Due to the relatively wide bandwidth of a typical carrier in 5G NR, 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. However, it is unclear how a base station and UE handle configuration parameters in some scenarios when the UE transitions from one state to another state, e.g., from the RRC_CONNECTED state to the RRC_IDLE state or the RRC_INACTIVE state, or from the RRC_INACTIVE state to the RRC_IDLE state.

### SUMMARY

In one aspect of this disclosure, a method, performed by a UE, of managing MBS communications after a state transition includes receiving MBS data from a RAN using MBS configuration parameters while the UE is in a connected state with the RAN, transitioning from the connected state to an idle state or an inactive state, and, while the UE is in the idle state or the inactive state, and based on whether the MBS configuration parameters are for receiving a broadcast MBS session or a non-broadcast MBS session, either continuing or not continuing, respectively, to receive MBS data using the MBS configuration parameters.

In another aspect of this disclosure, a method, performed by a UE, of managing MBS communications after a state transition includes receiving MBS data from a RAN via a first MRB and/or a second MRB while the UE is in a connected state with the RAN, receiving an RRC release message from the RAN while the UE is in the connected state, and, in response to the RRC release message, (i) transitioning from the connected state to an idle state or an inactive state, and (ii) releasing or suspending the first MRB. The method further includes receiving further MBS data from the RAN via the second MRB while the UE is in the idle state or the inactive RRC state.

In another aspect of this disclosure, a method, performed by a UE, of managing MBS communications after a state transition includes receiving MBS data from a RAN using MBS configuration parameters while the UE is in an inactive state and while retaining unicast configuration parameters, and transitioning from the inactive state to an idle state. The method also includes, in response to the transitioning, releasing the unicast configuration parameters, and receiving further MBS data from the RAN using the MBS configuration parameters while the UE is in the idle state.

In another aspect of this disclosure, a method, performed by a RAN node, of managing MBS communications includes transmitting MBS data to a UE via an MRB, determining to release the MRB for the UE, and, after the determining, and based on whether the UE is or is not configured with a DRB, either not transmitting or transmitting, respectively, an RRC release message to the UE.

In another aspect of this disclosure, a method, performed by a CU of a base station, of managing MBS communications includes transmitting MBS data to a UE via a DU of the base station and an MRB, and determining to release the MRB for the UE. The method also includes, after the determining, and based on whether the UE is or is not configured with a DRB, either not transmitting or transmitting, respectively, a first CU-to-DU message to the DU indicating that the DU is to release a UE context of the UE.

### BRIEF DESCRIPTION OF THE DRAWINGS

FIG. 1A is a block diagram of an example wireless communication system in which the techniques of this disclosure for managing transmission and reception of MBS information can be implemented;

FIG. 1B is a block diagram of an example distributed base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a distributed base station;

FIG. 3 is a block diagram illustrating example tunnel architectures for MBS sessions and PDU sessions;

FIG. 4 is a block diagram illustrating example MRBs and DRBs, which a distributed base station can configure for communicating multicast, broadcast, and/or unicast traffic with UEs;

FIGS. 5 and 6 are messaging diagrams of example scenarios in which a CN and a distributed base station configure resources for transmitting MBS data of one or more MBS sessions to multiple UEs;

FIGS. 7A-10B are flow diagrams of example methods for managing MBS configuration parameters and MBS data reception after a state transition, which can be implemented in a UE of FIG. 1A; and

FIGS. 11A-12B are flow diagrams of example methods for managing MBS configuration parameters, which can be implemented in a base station of FIG. 1A or in a DU of FIG. 1B.

### DETAILED DESCRIPTION OF THE DRAWINGS

Generally, a radio access network (RAN) and/or a core network (CN) implement the techniques of this disclosure to manage transmission of multicast and/or broadcast services (MBS). A CN can request that a base station configure a common downlink (DL) tunnel via which the CN can transmit MBS data for an MBS session to the base station, for multiple UEs. In response to the request, the base station transmits a configuration of the common DL tunnel to the CN. The configuration can include transport-layer information such as an Internet Protocol (IP) address and a tunnel identifier (e.g., a Tunnel Endpoint Identifier (TEID)).

The base station can also configure one or more logical channels toward the UEs, and/or configure one or more MBS radio bearers (MRBs) associated with the MBS session, where there may be a one-to-one mapping between each logical channel and each MRB. After receiving MBS data for the MBS session from the CN via the common DL tunnel, the base station can transmit the MBS data via the one or more logical channels to one or more UEs that have joined the MBS session. In some implementations, the base station transmits MBS data to multiple UEs via a single logical channel. Further, if there are multiple quality-of-service (QOS) flows for the MBS session, a single logical channel may be associated with the multiple QoS flows, or there may be a one-to-one mapping between each QoS flow and each logical channel.

The CN can cause the base station to configure the common DL tunnel before or after a UE joins the MBS session. If additional UEs join the MBS session after the tunnel is configured, the CN can utilize the same common DL tunnel to transmit MBS data, for the multiple UEs, to the base station.

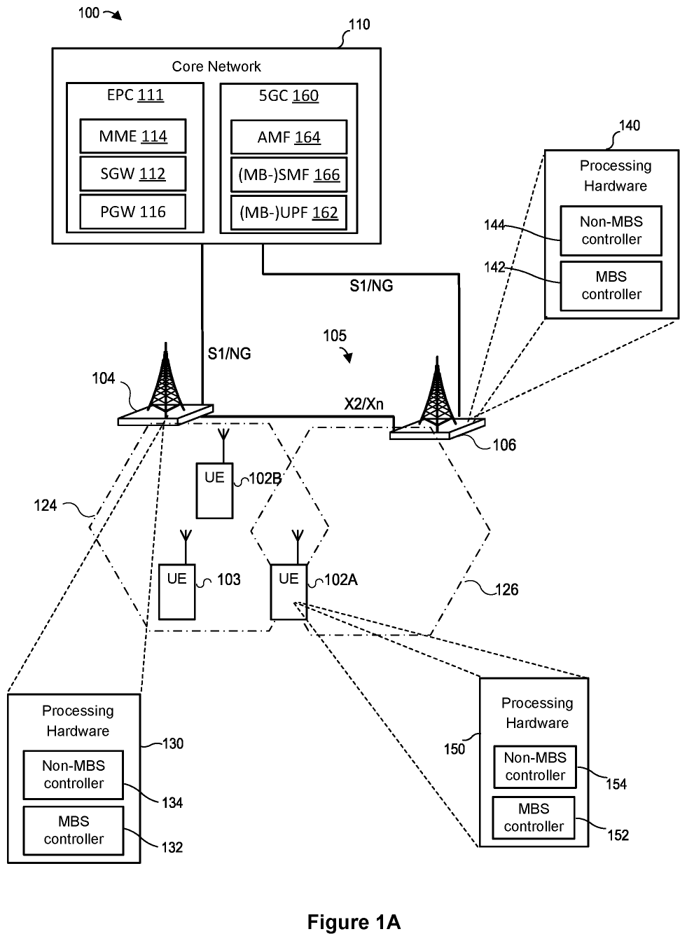

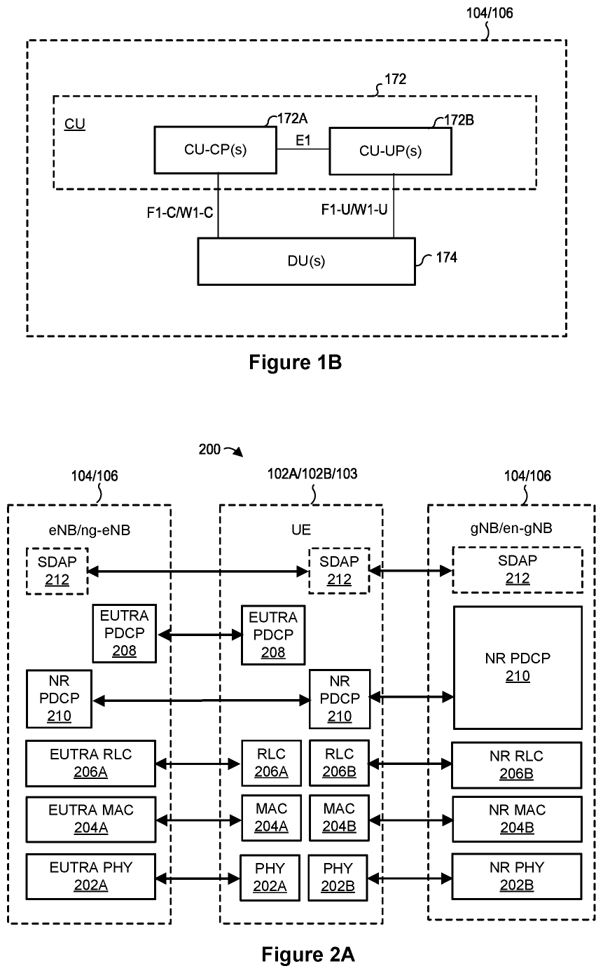

FIG. 1A depicts an example wireless communication system 100 in which techniques of this disclosure for managing transmission and reception of MBS information can be implemented. The wireless communication system 100 includes UEs 102A, 102B, 103, as well as base stations 104, 106 of a RAN 105 connected to a CN 110. In other implementations or scenarios, the wireless communication system 100 may instead include more or fewer UEs, and/or more or fewer base stations, than are shown in FIG. 1A. The base stations 104, 106 can be any suitable type, or types, of base stations, such as an evolved node B (eNB), a next-generation eNB (ng-NB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows for various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission (which can also be referred to as “early data transmission”) in the idle or inactive state.

In MBS operation, the UE 102A can use an MRB that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UEs 102B, 103 may each include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only. The UPF 162 and/or SMF 166 can be configured for both non-MBS unicast services and MBS services, or for MBS services only, as denoted by the prefix “(MB-)” shown in FIG. 1A.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of each of one or both of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

The description above can apply to the UEs 102B and/or 103 in the same manner as UE 102A.

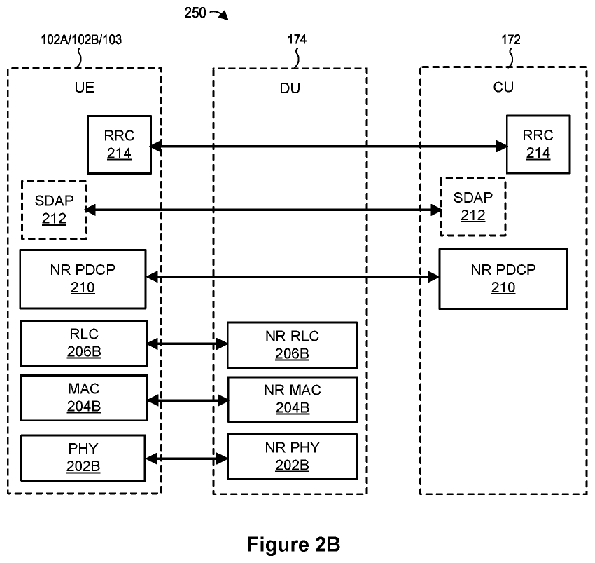

FIG. 2A illustrates, in a simplified manner, an example protocol stack 200 according to which a UE (e.g., UE 102A, 102B, or 103) can communicate with an eNB/ng-eNB or a gNB/en-gNB (e.g., one or both of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, at times this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE operates in EN-DC with the base station 104 operating as an MeNB and the base station 106 operating as an SgNB, the wireless communication system 100 can provide the UE with an MN-terminated bearer that uses EUTRA PDCP sublayer 208, or an MN-terminated bearer that uses NR PDCP sublayer 210. The wireless communication system 100 in various scenarios can also provide the UE with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104 or 106) broadcasts MBS data packets via one or more MRBs, and in turn the UE receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE uses PHY sublayer 202, MAC sublayer 204, and RLC sublayer 206 to receive the MBS data packets. In such implementations, the base station and the UE may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE uses PHY sublayer 202, MAC sublayer 204, RLC sublayer 206 and PDCP sublayer 208 to receive the MBS data packets. In such implementations, the base station and the UE may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE (e.g., UE 102A, 102B, or 103) can communicate with a DU (e.g., DU 174) and a CU (e.g., CU 172). The radio protocol stack 200 is functionally split as shown by the radio protocol stack 250 in FIG. 2B. The CU at either of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

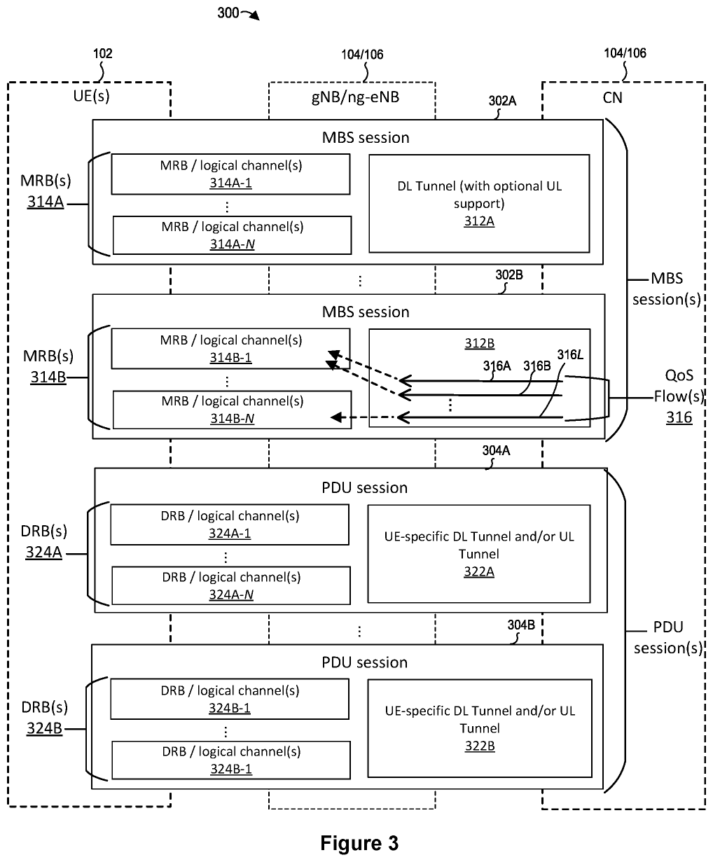

Referring next to FIG. 3, which depicts example tunnel architectures 300 for MBS sessions and PDU sessions, an MBS session 302A can include a tunnel 312A with endpoints at the CN 110 and the base station 104/106 (i.e., the base station 104 or the base station 106). The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, the CN 110 and the base station 104/106 use the tunnel 312A for downlink as well as for uplink (UL) MBS traffic to support, for example, commands or service requests from UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and an GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A, 316B, . . . 316L, where L>1. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific DL tunnel 322A corresponding to one or more DRBs 324A, such as a DRB 324A-1, 324A-2, . . . 324-N. Each of the DRBs 324A can correspond to a respective logical channel, such as a Dedicated Traffic Channel (DTCH).

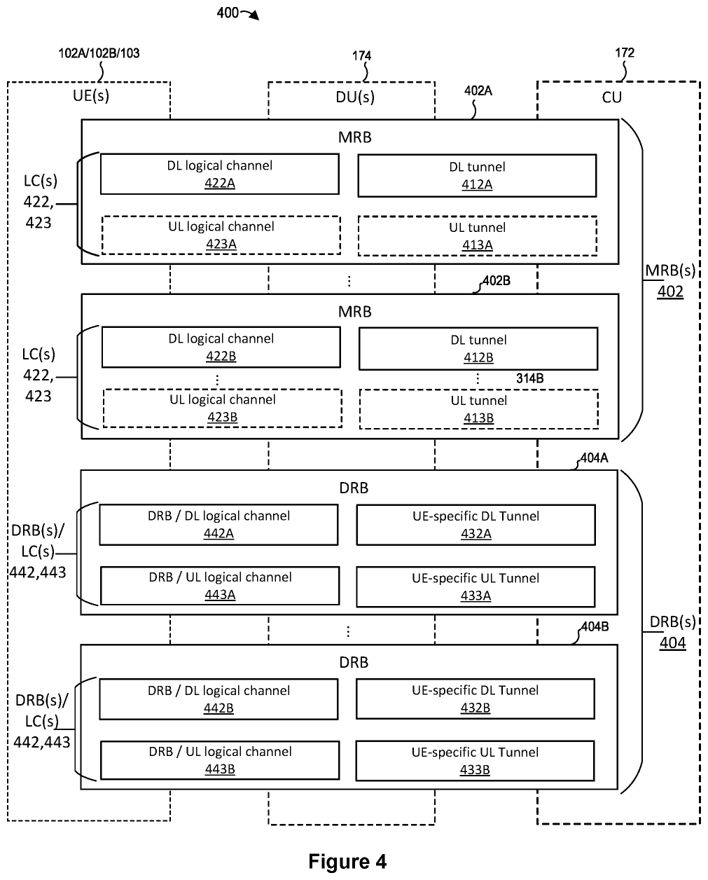

Now referring to FIG. 4, which depicts example MRB(s) and DRB(s) in the case where a base station (e.g., the base station 104 or 106) is implemented in a distributed manner, the CU 172 and the DU(s) 174 can establish tunnels for downlink data and/or uplink data associated with an MRB or a DRB. The MRB 314A-1 discussed above can be implemented as an MRB 402A connecting the CU 172 to multiple UEs such as (e.g., the UE 102A and 102B). The MRB 402A can include a DL tunnel 412A connecting the CU 172 and the DU(s) 174, and a DL logical channel 422A corresponding to the DL tunnel 412A. In particular, the DU(s) 174 can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU(s) 174, and a UL logical channel 423A corresponding to the UL tunnel 413A. The UL logical channel 423A can be a DTCH, for example. The DU(s) 174 can map uplink traffic received via the UL logical channel 423A to the UL tunnel 413A.

The tunnels 412A and 413A can operate at the transport layer or sublayer of the F1-U interface. As a more specific example, the CU 172 and the DU(s) 174 can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU(s) 174 can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., to the UE 102A or the UE 102B). The DRB 404A can include a UE-specific DL tunnel 432A connecting the CU 172 and the DU(s) 174, and a DL logical channel 442A corresponding to the DL tunnel 432A. In particular, the DU(s) 174 can map downlink traffic received via the DL tunnel 432A to the DL logical channel 442A, which can be a DTCH, for example. The DRB 404A further includes a UE-specific UL tunnel 433A connecting the CU 172 and the DU(s) 174, and a UL logical channel 443A corresponding to the UL tunnel 433A. The UL logical channel 443A can be a PUSCH, for example. The DU(s) 174 can map uplink traffic received via the UL logical channel 443A to the UL tunnel 433A.

Similarly, A DRB 404B can include a UE-specific DL tunnel 432B corresponding to a DL logical channel 442B, and a UE-specific UL tunnel 433B corresponding to a UL logical channel 443B.

In some implementations, a DU of the DU(s) 174 assigns a particular logical channel ID (value) for each of the logical channel(s) associated with the MRB(s) associated with the same MBS session or different MBS sessions. In other implementations, the DU assigns the same logical channel ID (value) for each of the logical channel(s) associated with the MRB(s) associated with different MBS sessions. In some implementations, the DU assigns a particular logical channel ID (value) for each of the logical channel(s) associated with the DRB(s). In some implementations, the DU sets logical channel IDs associated with the MRB(s) and DRB(s) respectively to different values. In other implementations, the DU sets logical channel IDs associated with the MRB(s) and DRB(s) respectively to the same values.

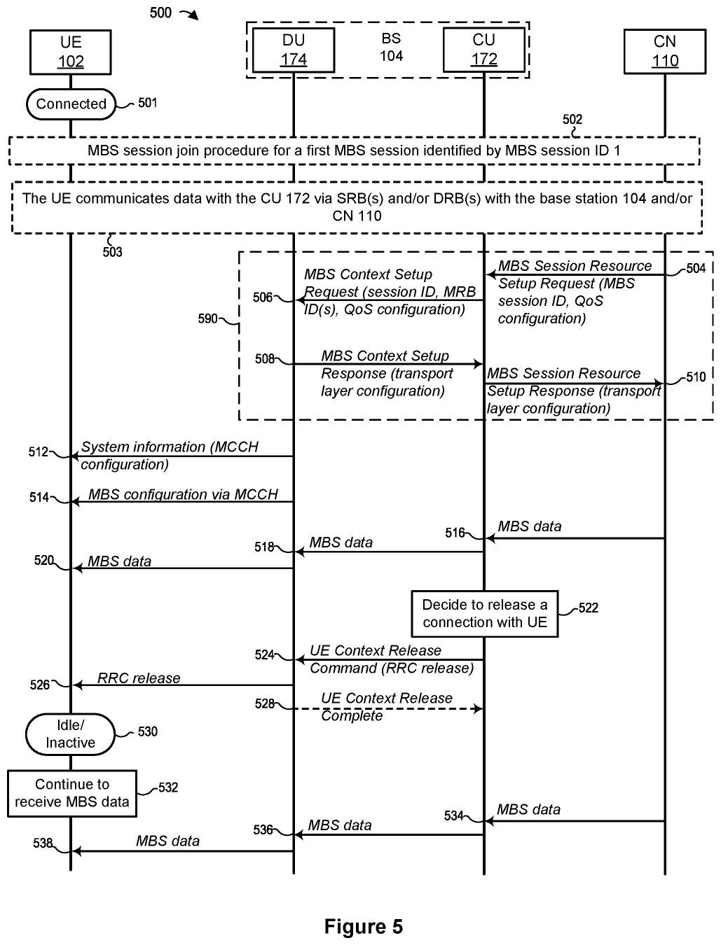

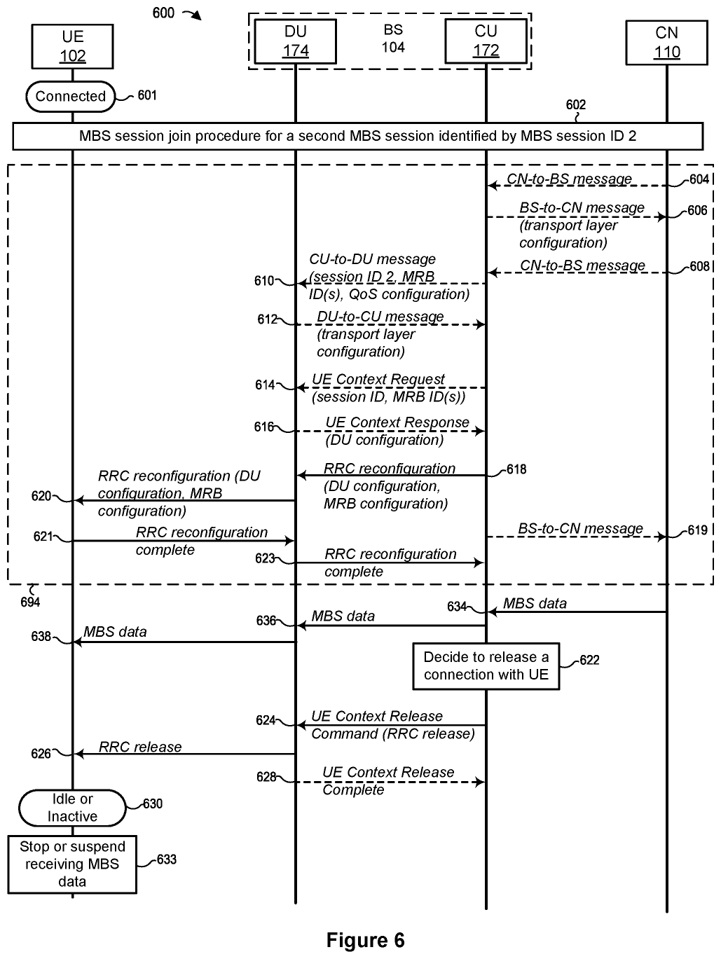

FIGS. 5 and 6 are messaging diagrams of example scenarios in which a CN and a distributed base station configure resources for transmitting MBS data of one or more MBS sessions to multiple UEs. Generally, similar events in FIGS. 5 and 6 are labeled with similar reference numbers (e.g., event 501 in FIG. 5 is similar to event 601 in FIG. 6), with differences discussed below where appropriate. With the exception of the differences shown in the figures and discussed below, any of the alternative implementations discussed with respect to a particular event (e.g., for messaging and processing) may apply to events labeled with similar reference numbers in other figures, and also to both integrated and distributed base stations.

FIG. 5 illustrates an example scenario 500 in which the base station 104 is a distributed base station including a CU 172 and a DU 174 (where “DU 174” refers to a single DU of the DU(s) 174 in FIG. 1B), and configures resources for transmitting MBS data of one or more MBS sessions via broadcast.

Initially the UE 102 operates 501 in a connected state (e.g., RRC_CONNECTED state). While FIGS. 5 and 6 depict only a single “UE 102,” it is understood that this can be either or both (each) of UEs 102A, 102B. The UE 102 in the connected state can perform a (first) MBS session join procedure 502 with the CN 110 via the base station 104 to join a certain MBS session (i.e., a first MBS session). Because the base station 104 configures a common DL tunnel for MBS traffic rather than a UE-specific tunnel, as discussed below, the procedure 502 and the procedure 590 (discussed below) can occur in either order. In other words, the base station 104 can configure a common DL tunnel before even a single UE joins the MBS session.

In some implementations, the UE 102 can perform a PDU session establishment procedure with the CN 110 via the base station 104 to establish a PDU session, in order to perform the (first) MBS session join procedure 502. During the PDU session establishment procedure, the UE 102 can communicate a PDU session ID of the PDU session with the CN 110 via the base station 104.

To perform the MBS session join procedure 502, the UE 102 in some implementations sends an MBS session join request message to the CN 110 via the base station 104. In response, the CN 110 can send an MBS session join response message to the UE 102 via the base station 104 to grant the UE 102 access to the first MBS session. In some implementations, the UE 102 can include a first MBS session ID (e.g., MBS session ID 1) of the first MBS session and/or the PDU session ID in the MBS session join request message. The CN 110 in some cases can include the first MBS session ID and/or the PDU session ID in the MBS session join response message. In some implementations, the UE 102 can send an MBS session join complete message to the CN 110 via the base station 104 in response to the MBS session join response message.

In some implementations, the MBS session join request message, MBS session join response message, and MBS session join complete message can be IP packets, HTTP packets, or session initiation protocol (SIP) messages. In such cases, these messages may not include the PDU session ID. In other implementations, the MBS session join request message, MBS session join response message, and MBS session join complete message can be NAS messages such as 5G mobility management (5GMM) messages or 5G session management messages (5GSM). In the case of the 5GSM messages, the UE 102 can transmit to the CN 110 via the base station 104 a (first) UL container message including the MBS session join request message, the CN 110 can transmit to the UE 102 (via the base station 104) a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can represent their respective container messages.

After the first MBS session join procedure 502, the UE 102 operating in the connected state can communicates 503 data with the CU 172 via one or more SRBs and/or one or more DRBs with the base station 104 and/or the CN 110. In some implementations, the UE 102 can have one or more state transitions between the connected state, an idle state (e.g., RRC_IDLE state), and/or an inactive state (e.g., RRC_INACTIVE state)), after performing the MBS session join procedure 502 and before performing the data communication 503.

Before, during, or after the first MBS session join procedure (event 502), the CN 110 can send 504 a (first) CN-to-BS message including the first MBS session ID (e.g., MBS session ID 1) and/or the PDU session ID to the CU 172 to request the CU 172 to configure resources for the first MBS session. The CN 110 can additionally include QoS configuration(s) for the first MBS session in the first CN-to-BS message. In response to receiving 504 the first CN-to-BS message, the CU 172 can send 506 a CU-to-DU message to the DU 174 to request a set-up for an MBS context and/or a common DL tunnel (i.e., a CU-to-DU common DL tunnel) for the first MBS session.

In response to receiving 506 the CU-to-DU message, the DU 174 can send 508, to the CU 172, a DU-to-CU message including a first DU DL transport layer configuration to configure a common CU-to-DU DL tunnel for the first MBS session or an MRB identified by one of the MRB ID(s). The DU 174 can include, in the DU-to-CU message, additional DL transport layer configuration(s) to configure additional common CU-to-DU DL tunnel(s) for additional MRB(s) identified by additional MRB ID(s) of the MRB IDs. In some implementations, the DU 174 can include, in the DU-to-CU message, the MRB ID(s) associated with the first DL transport layer configuration and/or the additional DL transport layer configuration(s). In some implementations, the CU-to-DU message is a generic F1AP message or a dedicated F1AP message defined specifically to convey this type of a request (e.g., MBS Context Setup Request message). In some implementations, the DU-to-CU message of event 508 is a generic F1AP message or a dedicated F1AP message defined specifically for this purpose (e.g., MBS Context Setup Response message). The CN 110 can additionally include QoS configuration(s) for the first MBS session. In such cases, the CU 172 can include the QoS configuration(s) in the CU-to-DU message (event 506). In some implementations, the CU-to-DU message and DU-to-CU message can be non-UE-specific messages.

The CU 172 sends 510 a first BS-to-CN message (e.g., MBS Session Resource Setup Response message) in response to the message of event 504. The CU 172 can include the first MBS session ID and/or the PDU session ID in the first BS-to-CN message. The first BS-to-CN message can include a DL transport layer configuration to configure a common DL tunnel (i.e., a CN-to-BS common DL tunnel) for the CN 110 to send MBS data to the CU 172. The DL transport layer configuration includes a transport layer information, such as a transport layer address (e.g., an IP address) and/or a TEID, to identify the common DL tunnel. In some implementations, the CN-to-BS message of event 504 is a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the MBS session. In some implementations, the QoS configuration(s) includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QOS flow of the QoS flow(s). In some implementations, the configuration parameters include QoS parameters for each QoS flow. The QoS parameters can include a 5G QoS identifier (5QI), a priority level, packet delay budget, packet error rate, averaging window, and/or a maximum data burst volume. The CN 110 can specify different values of the QoS parameters for the QoS flows.

The events 504, 506, 508, and 510 are collectively referred to in FIG. 5A as an MBS resource setup procedure 590. In cases where the UE 102 performs the MBS session join procedure 502 to join the first MBS session, the CN 110 can perform the procedure 590 with the base station 104 before, during, or after the (first) MBS session join procedure 502.

In some implementations, the CN 110 may refrain from including a UL transport layer configuration for the first MBS session in the first CN-to-BS message. In such cases, the CU 172 may refrain from including a UL transport layer configuration for the first MBS session in the CU-to-DU message.

Before, during, or after the MBS resource setup procedure 590, the DU 174 transmits (e.g., broadcasts) 512 system information (e.g., one or more system information blocks (SIBs)) including a MBS control channel (MCCH) configuration on one or more cells (e.g., cell 124 and/or other cell(s) operated by the DU 174). The DU 174 also transmits (e.g., broadcasts) 514 an MBS configuration via an MCCH configured by (i.e., in accordance with) the MCCH configuration. The UE 102 may receive 512 the system information and/or receive 514 the MBS configuration before or after performing the data communication 503.

In some implementations, the MCCH configuration includes configuration parameters such as a window start slot, a window duration, a modification period, and/or a repetition period and offset. The window duration indicates a duration (i.e., MCCH transmission window in units of, for example, (consecutive) slots), starting from a slot indicated by the window start slot, during which transmissions of MCCH information (i.e., transmission(s) of the MBS configuration(s) via MCCH) may be scheduled. The modification period defines periodically appearing boundaries, i.e., radio frames for which SFN mod the modification period equals 0. Contents of different transmissions of MCCH information can only be different if there is at least one such boundary between them. The repetition period and offset parameter defines a length and an offset of the MCCH repetition period. Transmissions of MCCH information are scheduled in radio frames for which (system frame number (SFN) mod the repetition period length offset of the repetition period) equals the offset of the MCCH repetition period.

In some implementations, the MBS configuration includes an MBS session information list, which in turn includes a list of MBS session information IE(s) (i.e., information related one or more MBS sessions including the first MBS session). For example, an MBS session information IE in the list may include an MBS session ID, a G-RNTI, MRB configuration(s), RLC configuration(s), and/or DRX information. If the MBS session ID identifies an MBS session, the G-RNTI is used to schedule transmissions of MBS data of the MBS session, the MRB configuration(s) configures one or more MRBs, the RLC configuration(s) configures RLC parameters for the MRB(s), and the DRX information configures DRX related parameters for transmission of MBS data of the MBS session. Each of the MRB configuration(s) can configure an MRB. For example, an MRB configuration may include a PDCP configuration for the MRB. In the scenario 500, an MBS session information IE (i.e., first MBS session information IE) in the list includes the first MBS session ID, MRB configuration(s) configuring one or more MRBs for the first MBS session, a (first) G-RNTI used by the DU 174 to schedule transmissions of MBS data of the MRB(s) or the first MBS session, RLC configuration(s) for the MRB(s), and/or DRX information configuring DRX related parameters for transmission of MBS data of the MRB(s) or the first MBS session.

In some implementations, the DU 174 can (start to) transmit 512 the system information in response to performing 590 the MBS resource setup procedure. In some implementations, the CU 172 generates the system information and transmits the system information to the DU 174. In other implementations, the DU 174 generates the system information.

In some implementations, the DU 174 can (start to) transmit 514 the MBS

configuration(s) in response to performing 590 the MBS resource setup procedure. In some implementations, the CU 172 generates the MBS configuration and transmit the MBS configuration to the DU 174. In other implementations, the DU 174 generates the MBS configuration as described below. In yet other implementations, the CU 172 generates a (first) portion of the MBS configuration, and the DU 174 generates a (second) portion of the MBS configuration (i.e., the rest of the MBS configuration). Details of these different implementations will be described below.

In some implementations, the CU 172 can transmit to the DU 174 a CU-to-DU message including configuration parameters for the first MBS session, such as the first MBS session ID, QoS configuration(s), DRX cycle configuration, MRB ID(s) of the MRB(s), and/or PDCP configuration(s) of the MRB(s). In some implementations, the DU 174 can generate the MBS session information IE in accordance with the configuration parameters. In some implementations, the DU 174 can generate at least a portion of the MBS session information IE, e.g., in accordance with preconfigured value(s). For example, the DU 174 can generate the MRB configuration(s), which includes the PDCP configuration(s), the MRB ID(s) and/or the first MBS session ID received from the CU 172. Alternatively, the DU 174 can generate the MRB configuration(s), which includes the PDCP configuration(s), the MRB ID(s) and/or the first MBS session ID with preconfigured values. In some implementations, the DU 174 may not include a MRB ID in the MRB configuration(s). The DU 174 can generate the RLC configuration(s) (e.g., including the MRB ID(s)) for the MRB(s), e.g., in accordance with the QoS configuration(s) and/or the MRB ID(s). Alternatively, the DU 174 can generate the RLC configuration(s) with pre-configured RLC parameters. The DU 174 can assign logical channel ID(s) for the MRB(s) and include the logical channel ID(s) in the MBS session information IE or the RLC configuration(s). In another example, the DU 174 can generate the DRX information configuring a DRX cycle in accordance with the DRX cycle configuration received from the CU 172. Alternatively, the DU 174 can determine the DRX cycle, e.g., in accordance with the QoS configuration(s) received from the CU 172. In yet another example, the DU 174 can assign the G-RNTI and associate the G-RNTI with the first MBS session ID. In such cases, the DU 174 can generate the MBS session information and the MBS configuration (e.g., an MBS broadcast configuration message) including the MBS session information, and transmit 514 the MBS configuration via the MCCH on the one or more cells. In some implementations, the CU-to-DU message can be a CU-to-DU message of the MBS resource setup procedure 590, similar to event 506. In other implementations, the CU-to-DU message can be a (second) message other than the CU-to-DU message of the MBS resource setup procedure 590.

In other implementations, the DU 174 can transmit to the CU 172 a DU-to-CU message including the RLC bearer configuration(s), the DRX information, and the G-RNTI. In such implementations, the CU 172 generates the MRB configuration(s), which includes the PDCP configuration(s), the MRB ID(s), and/or the first MBS session ID. After receiving the DU-to-CU message, the CU 172 generates the MBS session information and the MBS configuration (e.g., an MBS broadcast configuration message) including the MBS session information, for (each of) the one or more cells. The CU 172 then transmits a CU-to-DU message including the MBS configuration to the DU 174. After receiving the MBS configuration from the CU 172, the DU 174 transmits 513 the MRB configuration via the MCCH. In some implementations, the CU 172 can send a CU-to-DU message to the DU 174 to request the DU 174 to send the DU-to-CU message. In such cases, the DU 174 sends the DU-to-CU message to the CU 172 in response to the CU-to-DU message.

In some implementations, the DU 174 can transmit 508 the DU-to-CU message to the CU 172 after transmitting 512 the system information and/or transmitting 514 the MBS configuration. In other implementations, the DU 174 can transmit 508 the DU-to-CU message to the CU 172 before transmitting 512 the system information and/or transmitting 514 the MBS configuration.

After receiving 510 the first BS-to-CN message, transmitting 512 the system information, and/or transmitting 514 the MBS configuration, the CN 110 can send 516 MBS data (e.g., one or multiple MBS data packets) of the first MBS session to the CU 172 via the common CN-to-BS DL tunnel (i.e., the first common CN-to-BS DL tunnel), which in turn sends 518 the MBS data to the DU 174 in accordance with the PDCP configuration(s) via the common CU-to-DU DL tunnel (i.e., the first CU-to-DU common DL tunnel). The DU 174 transmits (e.g., broadcast) 520 the MBS data via the MRB (i.e., via the logical channel(s) identified by the logical channel ID(s), and/or using the RLC configuration(s) and/or G-RNTI). The UE 102 operating in the connected state with the base station 104 receives 520 the MBS data from the DU 174 via the MRB (i.e., in accordance with the first MBS session information IE). For example, the CU 172 may receive 516 an MBS data packet, generate a PDCP PDU including the MBS data packet using the PDCP configuration, and transmit 518 the PDCP PDU to the DU 174 via the first common CU-to-DU DL tunnel. In turn, the DU 174 generates a MAC PDU including the logical channel ID and the PDCP PDU, and transmits 520 the MAC PDU to the UE 102 using the first G-RNTI via broadcast. The UE 102 receives 520 the MAC PDU using the first G-RNTI, retrieves the PDCP PDU and the logical channel ID from the MAC PDU, identifies the PDCP PDU associated with the MRB, and retrieves the MBS data packet from the PDCP PDU using the PDCP configuration.

With continued reference to FIG. 5, the CU 172 can decide 522 to release a connection (i.e., the SRB(s) and the DRB(s)) with the UE 102. In response to the decision 522, the CU 172 generates an RRC release message (e.g., RRCRelease message) for the UE 102 and sends 524 a UE Context Release Command message including the RRC release message to the DU 174. In turn, the DU 174 transmits 526 the RRC release message to the UE 102. In response to the RRC release message, the UE 102 transitions 530 to the idle or inactive state and continues to receive MBS data via the MRB. Before or after sending 526 the RRC release message, the DU 174 can transmit 528 a UE Context Release Complete message to the CU 172 in response to the UE Context Release Command message.

In some implementations, the CU 172 generates a PDCP PDU including the RRC release message and sends 524 the UE Context Release Command message including the PDCP PDU to the DU 174, and the DU 174 retrieves the PDCP PDU from the UE Context Release Command message and transmits 526 the PDCP PDU to the UE 102 via the RLC layer 206B, MAC layer 204B, and PHY layer 202B. The UE 102 receives 526 the PDCP PDU from the DU 174 via the PHY layer 202B, MAC layer 204B and RLC layer 206B. For example, the DU 174 can generate a RLC PDU including the PDCP PDU, generate a MAC PDU including the RLC PDU and a logical channel ID associated with a SRB (e.g., SRB1), and transmits 526 the MAC PDU to the UE 102 via the PHY layer 202B. The UE 102 receives 526 the MAC PDU via the PHY layer 202B, retrieves the RLC PDU and logical channel ID, identifies the RLC PDU associated with the SRB in accordance with the logical channel ID, retrieves the PDCP PDU from the RLC PDU, retrieves the RRC release message from the PDCP PDU and processes the RRC release message.

After the UE 102 transitions 530 to the idle state or inactive state, the CN 110 sends 534 MBS data of the first MBS session to the CU 172 via the first common CN-to-BS DL tunnel, similar to the event 516. In turn, the CU 172 transmits 536 the MBS data to the DU 174 via the first common CU-to-DU DL tunnel, similar to the event 518. The DU 174 then transmits (e.g., broadcasts) 538 the MBS data, similar to the event 520. The UE 102 receives 538 the MBS data in accordance with the first MBS session information 514, similar to the event 520.

Next, FIG. 6 illustrates an example scenario 600 in which the base station 104, including a CU 172 and a DU 174, configures resources for transmitting MBS data of one or more MBS sessions via multicast or unicast.

The UE 102 (i.e., each of UE 102A and/or UE 102B) initially performs a (second) MBS session join procedure 602 with the CN 110 via the base station 104 to join a certain MBS session (i.e., a second MBS session identified by a second MBS session ID), similar to the procedure 502.

Before, during, or after the (second) MBS session join procedure 602, the CN 110 can send 604 a (first) CN-to-BS message including the MBS session ID and/or the PDU session ID to the CU 172 to request the CU 172 to configure resources for the MBS session. The CN 110 can additionally include, in the CN-to-BS message, QoS configuration(s) for the MBS session. In response, the CU 172 can (determine to) send 606 a (first) BS-to-CN message including a DL transport layer configuration to configure a common DL tunnel (i.e., a first common CN-to-BS DL tunnel) for the CN 110 to send MBS data to the CU 172. The DL transport layer configuration includes a transport layer address (e.g., an IP address) and/or a TEID to identify the common DL tunnel. The CU 172 can include the MBS session ID and/or the PDU session ID in the BS-to-CN message. In cases where the CU 172 has configured a common DL tunnel has for the MBS session before receiving the BS-to-CN message, the CU 172 determines not send the BS-to-CN message. That is, the CU 172 refrains from sending the BS-to-CN message.

In some implementations, the CN-to-BS message of event 604 can be a generic NGAP message or a dedicated NGAP message defined specifically for requesting resources for an MBS session (e.g., MBS Session Resource Setup Request message). In some implementations, the BS-to-CN message of event 606 is a generic NGAP message or a dedicated NGAP message defined specifically to convey resources for an MBS session (e.g., MBS Session Resource Setup Response message). In such cases, the CN-to-BS message of event 604 and the BS-to-CN message of event 606 can be non-UE-specific messages.

In some implementations, the CN 110 can indicate, in the CN-to-BS message of event 604, a list of UEs joining the MBS session. In other implementations, the CN 110 can send 608 to the CU 172 a second CN-to-BS message indicating a list of UEs joining the MBS session. The CN 110 can include the MBS session ID and/or the PDU session ID in the second CN-to-BS message. The CU 172 can send 619 a second BS-to-CN message to the CN 110 in response to the second CN-to-BS message 608. In such cases, the second CN-to-BS message and the second BS-to-CN message can be non-UE-specific messages. For example, the list of UEs may include the UE 102A and/or UE 102B. To indicate a list of UEs, the CN 110 can include a list of (CN UE interface ID, RAN UE interface ID) pairs, each identifying a particular UE of the UEs. For example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be an “AMF UE NGAP ID” and the “RAN UE interface ID” can be a “RAN UE NGAP ID.” In other implementations, the CN 110 can include a list of UE IDs, each identifying a particular UE in the set of UEs. In some implementations, the CN 110 can assign the UE IDs and send each of the UE IDs to a particular UE of the UEs in a NAS procedure (e.g., registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs).

In some alternative implementations, the CN 110 can send 608 to the CU 172 another, second CN-to-BS message indicating that the UE 102 (e.g., a single UE such as UE 102A or UE 102B) joins the MBS session. The CU 172 can send 619 another, second BS-to-CN message to the CN 110 in response to the second CN-to-BS message 608. In such cases, the CN 110 can include the MBS session join response message for the UE 102 in the second CN-to-BS message. The CU 172 can include a first CN UE interface ID and a first RAN UE interface ID, identifying the UE 102, in the second CN-to-BS message. In some implementations, the second CN-to-BS message and the second BS-to-CN message can be UE-specific NGAP messages, such as a PDU Session Resource Modify Request message and a PDU Session Resource Modify Response message, respectively.

In other implementations, the first CN-to-BS message can be a UE-specific NGAP message (e.g., PDU Session Resource Modify Request message) indicating that the UE 102 (e.g., a single UE such as UE 102A or UE 102B) joins the MBS session. The CN 110 can include an MBS session join response message for the UE 102 in the first CN-to-BS message. The CU 172 can include the first CN UE interface ID and the first RAN UE interface ID, identifying the UE 102, in the first CN-to-BS message. In some implementations, the first BS-to-CN message can be a generic NGAP message or a dedicated NGAP message defined specifically to convey resources for an MBS session (e.g., MBS Session Resource Setup Indication message or RAN Configuration Update message). The CN 110 can send 608 another, second CN-to-BS message (e.g., MBS Session Resource Setup Confirm message or RAN Configuration Update Acknowledge message) to the CU 172 in response to the first BS-to-CN message. The CU 172 can send 619 to the CN 110 another, second BS-to-CN message (e.g., PDU Session Resource Modify Response message) in response to the first CN-to-BS message.

In some implementations, the CN 110 can include the MBS session join response message for the UE 102 in another CN-to-BS message instead of the first CN-to-BS message or the second CN-to-BS message.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5Q1), a priority level, a packet delay budget, a packet error rate, an averaging window, and/or a maximum data burst volume. The CN 110 can specify different values of the QoS parameters for the QoS flows.

In cases where the CU 172 establishes the common DL tunnel for the MBS session as described above, the CU 172 may refrain from including a DL transport layer configuration for the MBS session in the second BS-to-CN message. In such cases, the CN 110 may refrain from including a UL transport layer configuration for the MBS session in the first CN-to-BS message and/or second CN-to-BS message.

In response to or after receiving 604 the first CN-to-BS message, transmitting 606 the first CN-to-BS message, or receiving 608 the second CN-to-BS message, the CU 172 can send 610 a CU-to-DU message to the DU 174 to request a set-up for an MBS context and/or a common DL tunnel for the MBS session. In response to receiving 610 the CU-to-DU message, the DU 174 can send 612, to the CU 172, a DU-to-CU message including a first DU DL transport layer configuration to configure a common CU-to-DU DL tunnel (i.e., a first CU-to-DU common DL tunnel) for the MBS session. In some implementations, the CU-to-DU message is a generic F1AP message or a dedicated F1AP message defined specifically to convey this type of a request (e.g., MBS Context Setup Request message). In some implementations, the DU-to-CU message of even 612 is a generic F1AP message or a dedicated F1AP message defined specifically for this purpose (e.g., MBS Context Setup Response message). In such cases, the CU 172 can include the QoS configuration(s) in the CU-to-DU message (event 610). In some implementations, the CU-to-DU message and DU-to-CU message can be non-UE-specific messages.

In response to or after receiving 604 the first CN-to-BS message, transmitting 606 the first CN-to-BS message, receiving 608 the second CN-to-BS message, transmitting 610 the CU-to-DU message, or receiving 612 the DU-to-CU message, the CU 172 can send 614 to the DU 174 a UE Context Request message for the UE 102. In some implementations, the CU 172 can include, in the UE Context Request message, the MBS session ID and/or MRB ID(s) of MRB(s) associated to the MBS session (ID). In response to the UE Context Request message, the DU 174 sends 616 to the CU 172 a UE Context Response message including configuration parameters for the UE 102A to receive MBS data of the MBS session. In some implementations, the CU 172 can include the QoS configuration(s) in the UE Context Request message. In such cases, the CU 172 may or may not include the QoS configuration(s) in the CU-to-DU message. (Some of) the configuration parameters may be associated to the MRB(s)/MRB ID(s). In some implementations, the DU 174 generates a DU configuration to include the configuration parameters and includes the DU configuration in the UE Context Response message. In some implementations, the DU configuration can be a CellGroupConfig IE. In other implementations, the DU configuration can be an MBS specific IE. In some implementations, the configuration parameters configure one or more logical channels (LCs). For example, the configuration parameters include one or more logical channel IDs (LCIDs) to configure the one or more logical channel. Each of the LCIDs identifies a particular logical channel of the one or more logical channels.

In some implementations the DU 174 transmits 612 the DU-to-CU message (in addition to transmitting 616 the UE Context Response message) in response to receiving 614 the UE Context Request message, instead of transmitting 612 the DU-to-CU message in response to receiving 610 the CU-to-DU message requesting to configure a common CU-to-DU DL tunnel. Then, the CU 172 can send a CU-to-DU response message to the DU 174 in response to the DU-to-CU message. In such cases, the DU-to-CU message and the CU-to-DU response message can be non-UE associated messages, i.e., the messages are not associated to a particular UE.

In some implementations, the CN 110 includes the QoS configuration(s) in the second CN-to-BS message. In such cases, the CN 110 may include the QoS configuration(s) in the first CN-to-BS message, or omit the QoS configuration(s). In some implementations, the DU 174 generates the configuration parameters for the UE 102 to receive MBS data of the MBS session in response receiving the CU-to-DU message or the UE Context Request message. In some implementations, the CU 172 includes the QoS configuration(s) in the UE Context Request message and/or the CU-to-DU message. The DU 174 can determine the content of the configuration parameters in accordance with the QoS configuration(s). When the CU 172 includes the QoS configuration(s) in neither the CU-to-DU message nor the UE Context Request message, the DU 174 can determine values of the configuration parameters in accordance with a predetermined QoS configuration.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

After receiving 616 the UE Context Response message, the CU 172 generates an RRC reconfiguration message including the configuration parameters and one or more MRB configurations and transmits 618 the RRC reconfiguration message to the DU 174. In turn, the DU 174 transmits 620 the RRC reconfiguration message to the UE 102. In response, the UE 102 then transmits 621 an RRC reconfiguration complete message to the DU 174, which in turn transmits 623 the RRC reconfiguration complete message to the CU 172.

In some implementations, the CU 172 generates a PDCP PDU including the RRC reconfiguration message and sends 618 a CU-to-DU message including the PDCP PDU to the DU 174, and the DU 174 retrieves the PDCP PDU from the CU-to-DU message and transmits 620 the PDCP PDU to the UE 102 via the RLC layer 206B, MAC layer 204B, and PHY layer 202B. The UE 102 receives 620 the PDCP PDU from the DU 174 via the PHY layer 202B, MAC layer 204B, and RLC layer 206B. In some implementations, the UE 102 generates a PDCP PDU including the RRC reconfiguration complete message and transmits 621 the PDCP PDU to the DU 174 via the RLC layer 206B, MAC layer 204B, and PHY layer 202B. The DU 174 receives 621 the PDCP PDU from the UE 102 via the PHY layer 202B, MAC layer 204B, and RLC layer 206B and sends 623 a DU-to-CU including the PDCP PDU to the CU 172. The CU 172 retrieves the PDCP PDU from the DU-to-CU message and retrieves the RRC reconfiguration complete message from the PDCP PDU.

Before or after receiving 616 the UE Context Response message, the CU 172 can send 619 the second BS-to-CN message to the CN 110 in response to the second CN-to-BS message of event 612. In some implementations, the CU 172 sends 619 the second BS-to-CN message to the CN 110 before receiving 623 the RRC reconfiguration complete message. In other implementations, the CU 172 sends 619 the second BS-to-CN message to the CN 110 after receiving 623 the RRC reconfiguration complete message. The CU 172 can include the first CN UE interface ID and the first RAN UE interface ID in the second BS-to-CN message. Alternatively, the CU 172 can include the first UE ID in the second BS-to-CN message.

The events 604, 606, 608, 612, 614, 616, 618, 619, 620, 622, and 623 are collectively referred to in FIG. 6 as an MBS resource setup and UE-specific MBS session configuration procedure 694. In some implementations, respective instances of the events 604 or 608, 614, 616, 618, 619, 620, 622, 623 occur for each of the UE 102A and the UE 102B. The configuration parameters for the UE 102A and the UE 102B to receive MBS data of the MBS session can be the same. In some implementations, the MBS session join procedure 602 includes the UE-specific MBS session resource setup procedure 694.

After receiving 606 the first BS-to-CN message or receiving 619 the second BS-to-CN message, the CN 110 can send 634 MBS data (e.g., one or multiple MBS data packets) to the CU 172 via the first common CN-to-BS DL tunnel (similar to the event 516 or 534), which in turn sends 636 the MBS data to the DU 174 via the first common CU-to-DU DL tunnel (similar to the event 518 or 536). The DU 174 transmits (e.g., multicast or unicast) 638 the MBS data via the one or more logical channels to the UE 102 (i.e., the UE 102A and/or the UE 102B), similar to the event 520 or 538. The UE 102 receives 638 the MBS data via the one or more logical channels, similar to the event 520 or 538. For example, the CU 172 may receive 634 an MBS data packet, generate a PDCP PDU including the MBS data packet using the PDCP configuration, and transmit 636 the PDCP PDU to the DU 174 via the first common CU-to-DU DL tunnel. In turn, the DU 174 generates a MAC PDU including the logical channel ID and the PDCP PDU, and transmits 638 the MAC PDU to the UE 102 via multicast or unicast. The UE 102 receives 638 the MAC PDU via multicast or unicast, retrieves the PDCP PDU and the logical channel ID from the MAC PDU, identifies the PDCP PDU associated with the MRB in accordance with the logical channel ID, and retrieves the MBS data packet from the PDCP PDU in accordance with a PDCP configuration within the MRB configuration.

In some implementations, the CU 172 can (determine to) configure a UE-specific CN-to-BS DL tunnel for the UE 102 in response to receiving the first or second CN-to-BS message. In such cases, the CU 172 can omit the event 606, and can include, in the second BS-to-CN message, a DL transport layer configuration configuring a UE-specific DL tunnel. The CN 110 can transmit 634 the MBS data to the CU 172 via the UE-specific CN-to-BS DL tunnel. In some implementations, the CU 172 can (determine to) configure a UE-specific CU-to-DU DL tunnel for the UE 102 in response to receiving the first or second CN-to-BS message. In such cases, the CU 172 can omit the event 610 and the DU 174 can include, in the UE Context Response message, a DL transport layer configuration configuring a UE-specific CU-to-DU DL tunnel. In such cases, the CU 174 can transmit 636 the MBS data to the DU 174 via the UE-specific CU-to-DU DL tunnel.

In some implementations, the one or more MRB configurations configuring one or more MRBs are associated with the MBS session. In some implementations, the configuration parameters also include one or more RLC bearer configurations, each associated with a particular MRB. Each of the MRB configuration(s) can include a MRB ID, a PDCP configuration, the MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a MTCH. In other implementations, the logical channel can be a DTCH. In some implementations, the configuration parameters may include logical channel configuration (e.g., LogicalChannelConfig IE) configuring the logical channel. In some implementations, the RLC bearer configuration may include the MRB ID.

In some implementations, the CU 172 can configure the MRB as a DL-only RB in the MRB configuration. For example, the CU 172 may refrain from including UL configuration parameters in the PDCP configuration within the MRB configuration to configure the MRB as a DL only RB. Instead, the CU 172 only includes DL configuration parameters in the MRB configuration, e.g., as described above. In such cases, the CU 172 configures the UE 102 not to transmit UL PDCP data PDU via the MRB to the DU 174 and/or the CU 172 by excluding the UL configuration parameters for the MRB in the PDCP configuration in the MBR configuration. In another example, the DU 174 refrains from including UL configuration parameters in the RLC bearer configuration. In such cases, the DU 174 configures the UE 102 not to transmit control PDU(s) via the logical channel to the DU 174 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE to receive MBS data with a (de)compression protocol (e.g., robust header compression (ROHC) protocol), e.g., in the MRB configuration. In this case, when the CU 172 receives 634 an MBS data packet from the CN 110, the CU 172 compresses the MBS data packet with the compression protocol to obtain a compressed MBS data packet and transmits 636 a PDCP PDU including the compressed MBS data packet to the DU 174 via the common CU-to-DU DL tunnel. In turn, the DU 174 transmits (e.g., multicast or unicast) 638 the PDCP PDU to the UE 102 via the logical channel. When the UE 102 receives 638 the PDCP PDU via the logical channel, the UE 102 retrieves the compressed MBS data packet from the PDCP PDU. The UE 102 decompresses the compressed MBS data packet with the (de) compression protocol to obtain the original MBS data packet. In such cases, the UE 102 may transmit a PDCP Control PDU including a header compression protocol feedback (e.g., interspersed ROHC feedback) for operation of the header (de)compression protocol, via the logical channel and to the DU 174. In turn, the DU 174 sends the PDCP Control PDU to the CU 172 via a UE-specific UL tunnel, i.e., the UL tunnel is specific for the UE 102 (e.g., the UE 102A). In some implementations, the CU 172 can include, in the UE Context Request message, a CU UL transport layer configuration configuring the UE-specific UL tunnel. The CU UL transport layer configuration includes a CU transport layer address (e.g., an Internet Protocol (IP) address) and a CU UL TEID to identify the UE-specific UL tunnel.

In some implementations, the MRB configuration can be an MRB-ToAddMod IE including an MRB ID (e.g., mrb-Identity or MRB-Identity). An MRB ID identifies a particular MRB of the MRB(s). The CU 172 sets the MRB IDs to different values. In cases where the CU 172 has configured DRB(s) to the UE 102 for unicast data communication, the CU 172 in some implementations can set the MRB ID(s) to values different from DRB ID(s) of the DRB(s). In such cases, the UE 102 and the CU 172 can distinguish whether an RB is an MRB or DRB in accordance an RB ID of the RB. In other implementations, the CU 172 can set one or more of the MRB ID(s) to values which can be the same as one or more of the DRB ID(s). In such cases, the UE 102 and the CU 172 can distinguish whether an RB is an MRB or DRB in accordance an RB ID of the RB and a RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is a DRB if the UE 102 receives a DRB-ToAddMod IE configuring the RB, and determine an RB is an MRB if the UE 102 receives an MRB-ToAddMod IE configuring the RB. Similarly, the CU 172 can determine an RB is a DRB if the CU 172 transmits a DRB-ToAddMod IE configuring the RB to the UE 102, and determine an RB is an MRB if the CU 172 transmits an MRB-ToAddMod IE configuring the RB to the UE 102.

In some implementations, the configuration parameters for receiving MBS data of the MBS session include one or more logical channel (LC) IDs to configure one or more logical channels. In some implementations, the logical channel(s) can be DTCH(s). In other implementations, the logical channel(s) can be MTCH(s). In some implementations, the configuration parameters may or may not include a group radio network temporary identifier (G-RNTI). The RRC reconfiguration messages for UEs (e.g., the UE 102A and the UE 102B) joining the MBS session include the same configuration parameters as those for receiving MBS data of the MBS session. In some implementations, the RRC reconfiguration messages for the UEs may include the same or different configuration parameters as those for receiving non-MBS data.

In some implementations, the CU 172 can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU 172 via the DU 174. The UL RRC message can be a ULInformationTransfer message or any suitable RRC message that can include a UL NAS PDU. The CU 172 can include the MBS session join complete message in the second BS-to-CN message. Alternatively, the CU 172 can send to the CN 110 a BS-to-CN message (e.g., an UPLINK NAS TRANSPORT message) including the MBS session join complete message.

In other implementations, the CU 172 transmits a DL RRC message including an MBS session join response message to the UE 102 via the DU 174. The DL RRC message can be a DLInformationTransfer message, another RRC reconfiguration message, or any suitable RRC message that can include a DL NAS PDU. The UE 102 can send a UL RRC message including the MBS session join complete message to the CU 172 via the DU 174. The UL RRC message can be a ULInformationTransfer message, another RRC reconfiguration complete message, or any suitable RRC message that can include a UL NAS PDU.

With continued reference to FIG. 6, the CU 172 can decide 622 to release a connection (i.e., the SRB(s) and the DRB(s)) with the UE 102. In response to the decision 622, the CU 172 generates an RRC release message (e.g., RRCRelease message) for the UE 102 and sends 624 a UE Context Release Command message including the RRC release message to the DU 174. In turn, the DU 174 transmits 626 the RRC release message to the UE 102. In response to the RRC release message, the UE 102 transitions 630 to the idle or inactive state and stops 633 (or suspends) receiving MBS data via the MRB. Before or after sending 626 the RRC release message, the DU 174 can transmit 628 a UE Context Release Complete message to the CU 172 in response to the UE Context Release Command message.

In some implementations, the CU 172 generates a PDCP PDU including the RRC release message and sends 624 the UE Context Release Command message including the PDCP PDU to the DU 174, and the DU 174 retrieves the PDCP PDU from the UE Context Release Command message and transmits 626 the PDCP PDU to the UE 102 via the RLC layer 206B, MAC layer 204B, and PHY layer 202B. The UE 102 receives 626 the PDCP PDU from the DU 174 via the PHY layer 202B, MAC layer 204B, and RLC layer 206B. For example, the DU 174 can generate an RLC PDU including the PDCP PDU, generate a MAC PDU including the RLC PDU and a logical channel ID associated with a SRB (e.g., SRB1), and transmit 626 the MAC PDU to the UE 102 via the PHY layer 202B. The UE 102 receives 626 the MAC PDU via the PHY layer 202B, retrieves the RLC PDU and logical channel ID, identifies the RLC PDU associated with the SRB in accordance with the logical channel ID, retrieves the PDCP PDU from the RLC PDU, retrieves the RRC release message from the PDCP PDU, and processes the RRC release message.

After the UE 102 transitions 630 to the idle state or inactive state, the CN 110 can send MBS data of the MBS session to the CU 172 via the first common CN-to-BS DL tunnel, similar to the event 516. In turn, the CU 172 transmits the MBS data to the DU 174 via the first common CU-to-DU DL tunnel, similar to the event 518. The DU 174 then transmits (e.g., broadcasts) the MBS data, similar to the event 520. However, the UE 102 operating in the idle or inactive state does not receive the MBS data because the UE 102 has stopped receiving MBS data upon transitioning 630 to the idle or inactive state.

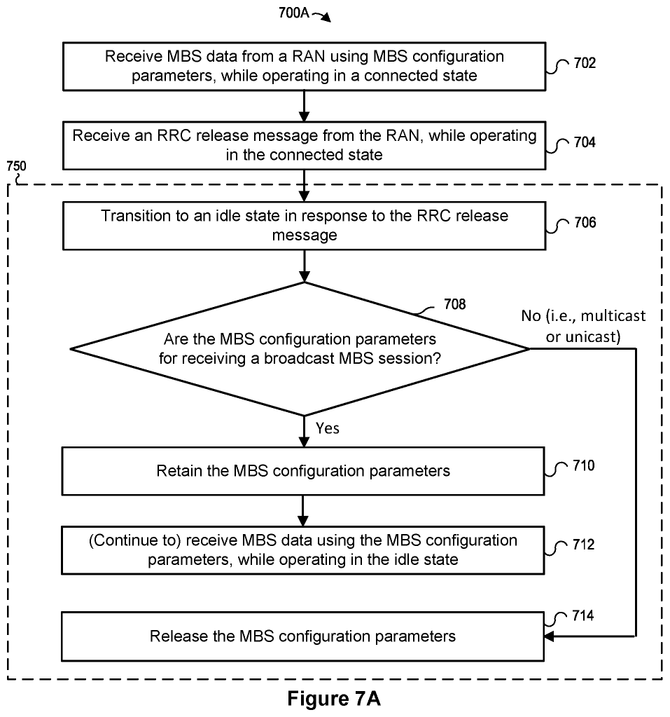

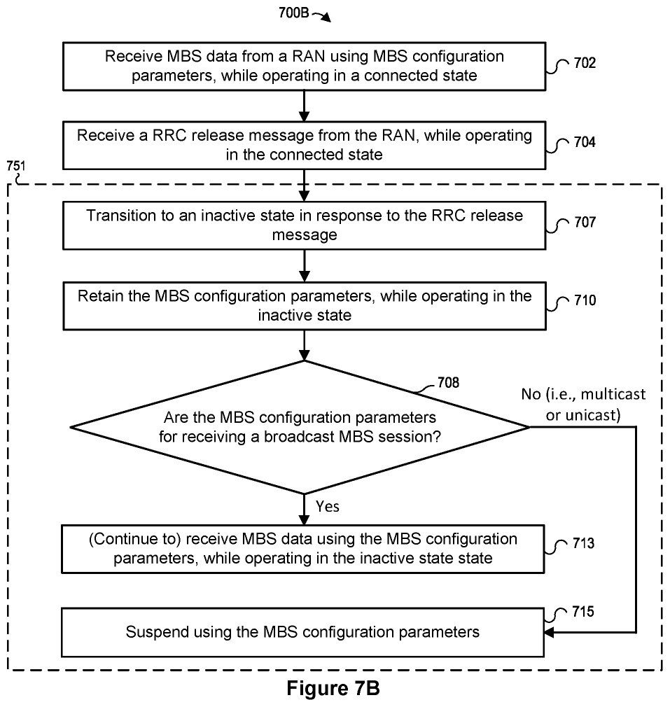

Next, several example methods that can be implemented in a UE (e.g., the UE 102A), a RAN (e.g., the RAN 105) or a base station (e.g., the base station 104) are discussed with reference to FIGS. 7A-12B. Each of these methods can be implemented using processing hardware such as one or more processors to execute instructions stored on a non-transitory computer-readable medium such as computer memory.

Referring first to FIG. 7A, a method 700A can be implemented in (performed by) a suitable UE. For clarity, the method 700A is discussed with specific reference to the RAN 105 and the UE 102 (i.e., the UE 102A or 102B).

At block 702, the UE 102 receives MBS data from the RAN 105 using MBS configuration parameters, while the UE 102 is operating in a connected state (e.g., event 520 of FIG. 5 or event 638 of FIG. 6). In some implementations, the MBS configuration parameters include at least one of an MRB configuration, an RLC configuration associated with the MRB configuration, a G-RNTI, MBS BWP configuration, and/or an MBS common frequency range configuration. At block 704, the UE 102 receives an RRC release message from the RAN 105, while the UE 102 is operating in the connected state (e.g., event 526 of FIG. 5 or event 626 of FIG. 6). At block 706, the UE 102 transitions to an idle state in response to the RRC release message. Then, at block 708, the UE 102 determines whether the MBS configuration parameters are (or were) or are not (or were not) used for receiving a broadcast MBS session. If the MBS configuration parameters are or were not used for receiving a broadcast MBS session (i.e., the MBS configuration parameters are or were used for receiving a unicast or multicast MBS session), then the flow continues to block 714 where the UE 102 releases the MBS configuration parameters (e.g., event 633 of FIG. 6). If the MBS configuration parameters are or were used for receiving a broadcast MBS session, however, the flow proceeds to block 710. At block 710, the UE 102 retains the MBS configuration parameters. At block 712, the UE 102 continues to receive MBS data using the MBS configuration parameters, while operating in the idle state (e.g., event 532 of FIG. 5). The blocks 706, 708, 710, 712, and 714 are collectively referred to in FIG. 7A as a transition to idle state procedure 750.

Referring next to FIG. 7B, a method 700B is generally similar to the method 700A, but the UE 102 transitions to an inactive state in response to the RRC release message. The differences between the methods of FIG. 7A and FIG. 7B are discussed in more detail below.

At block 707, the UE 102 transitions to an inactive state in response to the RRC release message, rather than the idle state of block 706. At block 710, the UE 102 retains the MBS configuration parameters, while operating in the inactive state (i.e., after transitioning to the inactive state). Then, at block 708, the UE 102 determines whether the MBS configuration parameters are (or were) or are not (or were not) used for receiving a broadcast MBS session. If the MBS configuration parameters are (or were) not used for receiving a broadcast MBS session (i.e., the MBS configuration parameters are (or were) used for receiving a unicast or multicast MBS session), then the flow continues to block 715 where the UE 102 suspends its use of the MBS configuration parameters (e.g., event 633 of FIG. 6). If the MBS configuration parameters are (or were) used for receiving a broadcast MBS session, however, the flow proceeds to block 713. At block 713, the UE 102 continues to receive MBS data using the MBS configuration parameters, while operating in the inactive state (e.g., events 532 of FIG. 5). The blocks 707, 710, 708, 713, and 715 are collectively referred to in FIG. 7A as an inactive state transition procedure 751.

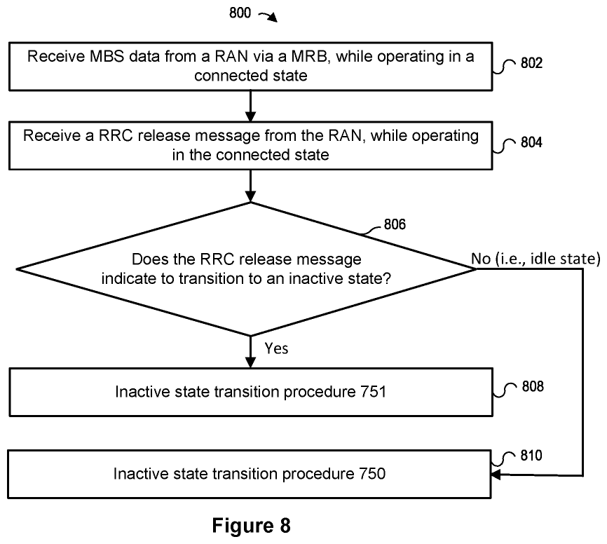

Referring now to FIG. 8, a method 800 can be implemented in (performed by) a suitable UE. For clarity, the method 800 is discussed with specific reference to the RAN 105 and the UE 102 (i.e., the UE 102A or 102B).

At block 802, the UE 102 receives MBS data from the RAN 105 using MBS configuration parameters, while the UE 102 is operating in a connected state (e.g., event 520 of FIG. 5 or event 638 of FIG. 6). At block 804, the UE 102 receives an RRC release message from the RAN 105, while operating in the connected state (e.g., event 526 of FIG. 5 or 626 of FIG. 6). Then, at block 806, the UE 102 determines whether the RRC release message indicates or does not indicate to transition to an inactive state. If RRC release message indicates to transition to an inactive state, the flow continues to block 808 where the UE 102 performs the inactive state transition procedure 751. If the RRC release message does not indicate to transition to an inactive state (i.e., transition to the idle state), the flow proceeds to the block 810, where the UE performs the inactive state transition procedure 750.

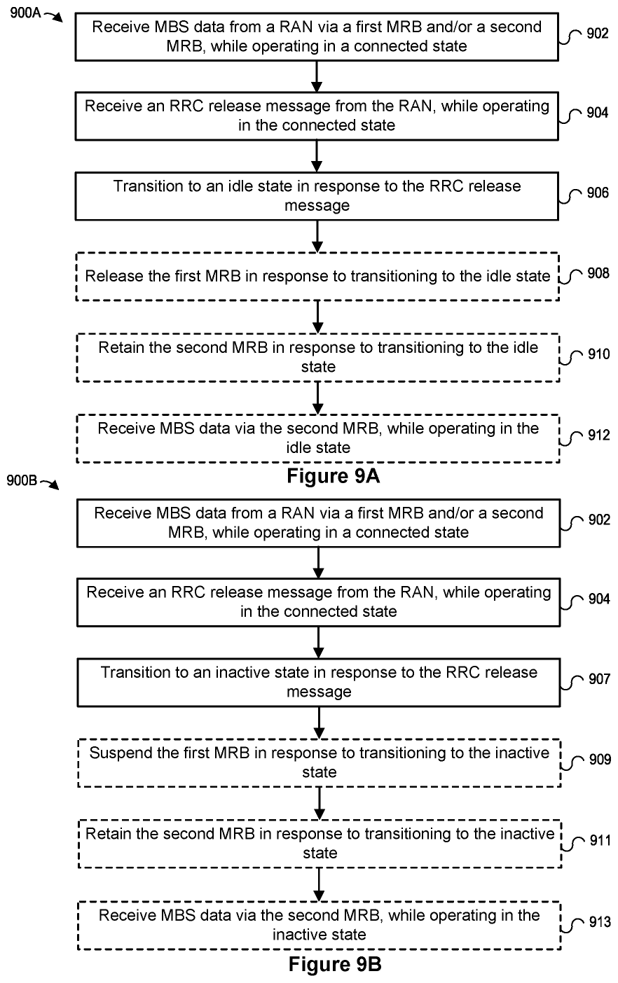

Referring now to FIG. 9A, a method 900A can be implemented in (performed by) a suitable UE. For clarity, the method 900A is discussed with specific reference to the RAN 105 and the UE 102.

At block 902, the UE 102 receives MBS data from the RAN 105 via a first MRB and a second MRB, while the UE 102 is operating in a connected state (e.g., event 520 of FIG. 5 or event 638 of FIG. 6). At block 904, the UE 102 receives an RRC release message from the RAN 105, while the UE 102 is operating in the connected state (e.g., event 526 of FIG. 5 or event 626 of FIG. 6). At block 906, the UE 102 transitions to an idle state in response to the RRC release message. Then, at block 908, the UE 102 releases the first MRB in response to transitioning to the idle state (e.g., event 633 of FIG. 6). At block 910, the UE 102 retains the second MRB in response to transitioning to the idle state. At block 912, the UE 102 continues to receive MBS data via the second MRB, while operating in the idle state (e.g., event 532 of FIG. 5).

Referring next to FIG. 9B, a method 900B is generally similar to the method 900A, but the UE 102 transitions to an inactive state in response to the RRC release message. The differences between the methods of FIG. 9A and FIG. 9B are discussed in more detail below.

After the UE 102 receives an RRC release message from the RAN 105, while the UE 102 is operating in the connected state, the flow continues to block 907. At block 907, the UE 102 transitions to an inactive state (rather than the idle state of method 900A) in response to the RRC release message. Then, at block 909, the UE 102 suspends the first MRB in response to transitioning to the inactive state (e.g., event 633 of FIG. 6). At block 911, the UE 102 retains the second MRB in response to transitioning to the inactive state. At block 913, the UE 102 continues receives MBS data using the MBS configuration parameters, while operating in the idle state (e.g., events 532 of FIG. 5).

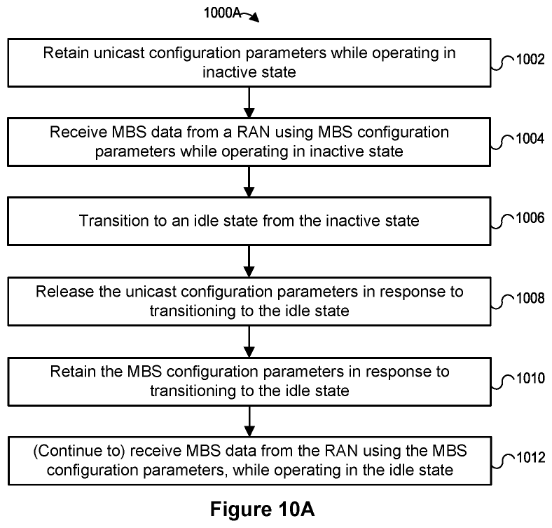

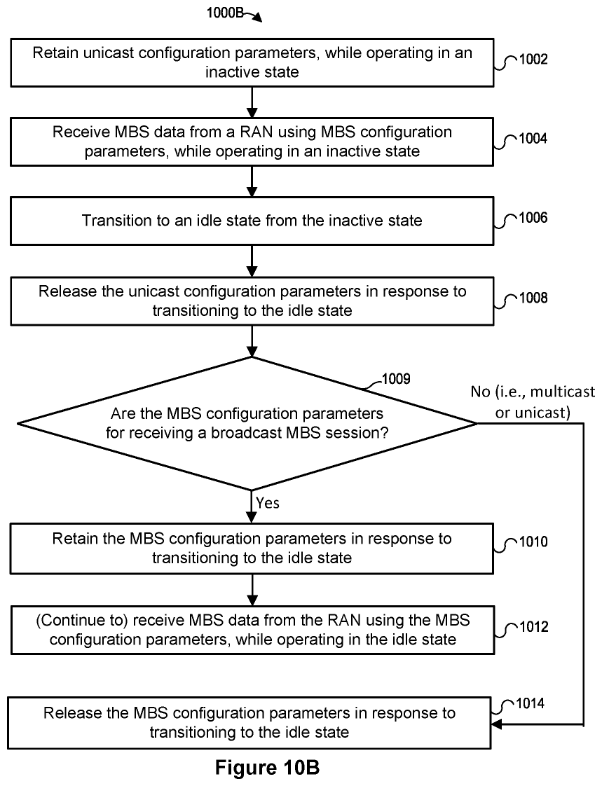

Referring now to FIG. 10A, a method 1000A can be implemented in (performed by) a suitable UE. For clarity, the method 1000A is discussed with specific reference to the RAN 105 and the UE 102 (i.e., the UE 102A or 102B).

At block 1002, the UE 102 retains unicast configuration parameters while operating in an inactive state. At block 1004, the UE 102 receive MBS data from the RAN 105 using MBS configuration parameters, while the UE 102 is operating in the inactive state. At block 1006, the UE 102 transitions to an idle state from the inactive state. Then, at block 1008, the UE 102 releases the unicast configuration parameters in response to transitioning to the idle state. At block 1010, the UE 102 retains the MBS configuration parameters in response to transitioning to the idle state. At block 1012, the UE 102 continues to receive MBS data from the RAN 105 using the MBS configuration parameters, while the UE 102 is operating in the idle state.

Referring next to FIG. 10B, a method 1000B is generally similar to the method 1000A, but the UE 102 may release MBS configuration parameters in response to transitioning to the idle state. The differences between the methods of FIG. 9A and FIG. 9B are discussed in more detail below.

After the UE 102 releases (at block 1008) the unicast configuration parameters in response to transitioning to the idle state, the flow continues to block 1009. At block 1009, the UE 102 determines whether the MBS configuration parameters are (or were) or are not (or were not) for receiving a broadcast MBS session. If the MBS configuration parameters are (or were) used for receiving a broadcast MBS session, then the flow continues to block 1010 where the UE 102 retains the MBS configuration parameters in response to transitioning to the idle state. At block 1012, the UE 102 continues to receive MBS data from the RAN 105 using the MBS configuration parameters, while the UE 102 is operating in the idle state. If the MBS configuration parameters are (or were) not used for receiving a broadcast MBS session (i.e., the MBS configuration parameters are (or were) used for receiving a unicast or multicast MBS session), the flow proceeds to block 1014. At block 1014, the UE 102 releases the MBS configuration parameters in response to transitioning to the idle state

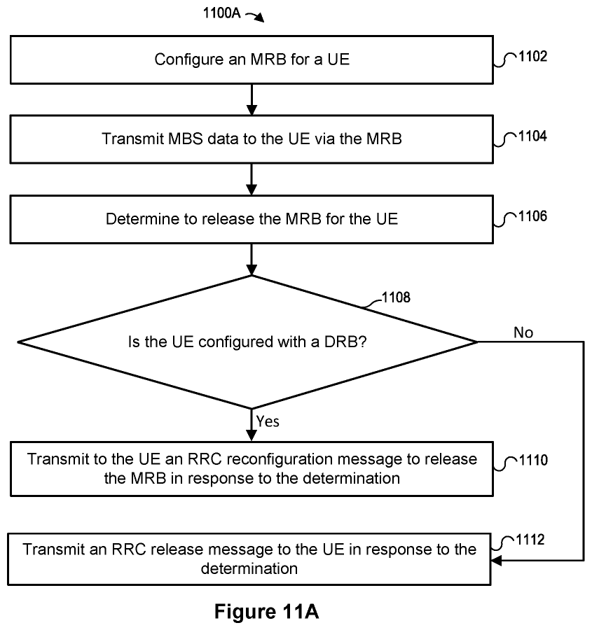

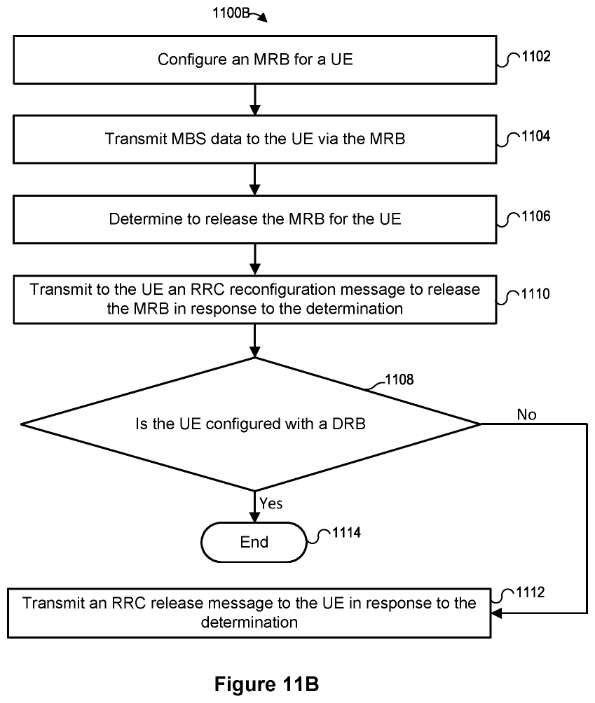

Referring now to FIG. 11A, a method 1100A can be implemented in (performed by) a base station of a suitable RAN. For clarity, the method 1100A is discussed with specific reference to the base station 104, RAN 105, and the UE 102 (i.e., the UE 102A or 102B).

At block 1102, the RAN 105 configures an MRB for the UE 102 (e.g., event 620 of FIG. 6). At block 1104, the RAN 105 transmits MBS data to the UE 102 via the MRB (e.g., event 638 of FIG. 6). At block 1106, the RAN 105 determines to release the MRB for the UE 102. Then, at block 1108, the RAN 105 determines whether the UE 102 is configured or is not configured with a DRB. If the UE 102 is configured with a DRB, then the flow continues to block 1110 where, in response to the determination, the RAN 105 causes the UE 102 to release the MRB by transmitting to the UE 102 an RRC reconfiguration message. If the UE 102 is not configured with a DRB, the flow proceeds to block 1112. At block 1112, in response to the determination, the RAN 105 does not cause the UE 102 to release the MRB, and instead transmits an RRC release message to the UE 102 (e.g., event 626 of FIG. 6).

Referring next to FIG. 11B, a method 1100B is generally similar to the method 1100A, but the RAN 105 transmits an RRC reconfiguration message to the UE 102 to release MRB irrespective of the DRB configuration. The differences between the methods of FIG. 11A and FIG. 11B are discussed in more detail below.

After determining to release the MRB for a UE 102 at block 1106, the flow continues to block 1110. At block 1110, in response to the determination, the RAN 105 causes the UE 102 to release the MRB by transmitting to the UE 102 an RRC reconfiguration message, irrespective of whether the UE 102 is configured with a DRB. Then, at block 1108, the RAN 105 determines whether the UE 102 is configured or is not configured with a DRB. If the UE 102 is configured with a DRB, then the flow continues to block 1114, where the procedure ends. If the UE 102 is not configured with a DRB, however, the flow proceeds to block 1112. At block 1112, in response to the determination, the RAN 105 transmits an RRC release message to the UE (e.g., event 626 of FIG. 6).

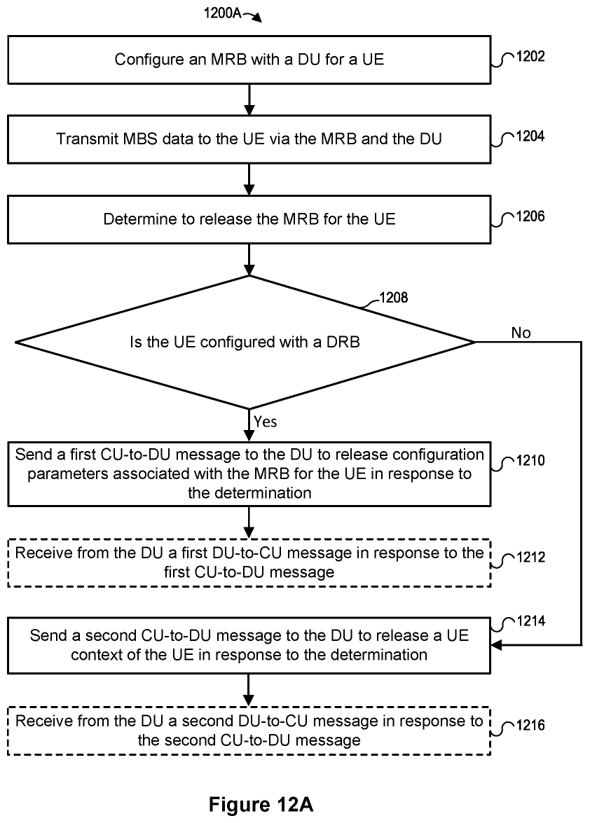

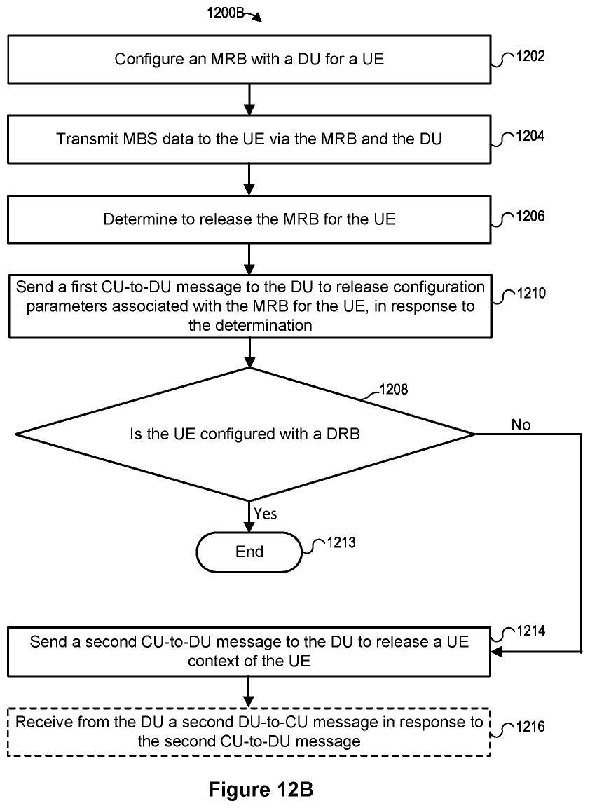

Referring now to FIG. 12A, a method 1200A can be implemented in (performed by) a suitable CU of a base station. For clarity, the method 1200A is discussed with specific reference to the base station 104, CU 172, DU 174, RAN 105, and UE 102 (i.e., the UE 102A or 102B).

At block 1202, a CU 172 configures an MRB with a DU 174 for a UE 102 (e.g., event 618 or event 620 of FIG. 6). At block 1204, the CU 172 transmits MBS data to the UE 102 via the MRB and the DU 174 (e.g., event 636 or event 638 of FIG. 6). At block 1206, the CU 172 determines to release the MRB for the UE 102. Then, at block 1208, the CU 172 determines whether the UE 102 is configured or is not configured with a DRB. If the UE 102 is configured with a DRB, then the flow continues to block 1210 where, in response to the determination, the CU 172 causes the DU 174 to release configuration parameters associated with the MRB for the UE 102 by transmitting a first CU-to-DU message to the DU 174. In some implementations, the flow continues to block 1212 from block 1210. At block 1212, the CU 172 receives from the DU 174 a first DU-to-CU message in response to the first CU-to-DU message. In some implementations, the first CU-to-DU message and the first DU-to-CU message are a UE Context Modification Request message and a UE Context Modification Response message, respectively. In other implementations, the first CU-to-DU message and the first DU-to-CU message are a UE Context Setup Request message and a UE Context Setup Response message, respectively.

If the UE 102 is not configured with a DRB, the flow proceeds to block 1214. At block 1214, in response to the determination, the CU 172 causes the DU 174 to release a UE context of the UE 102 by transmitting a second CU-to-DU message to the DU 174 (e.g., event 624 of FIG. 6). In some implementations, the flow continues to block 1216 from block 1214. At block 1216, the CU 172 receives from the DU 174 a second DU-to-CU message in response to the second CU-to-DU message (e.g., event 624 of FIG. 628). In some implementations, the second CU-to-DU message and the second DU-to-CU message are a UE Context Release Command message and a UE Context Release Complete message, respectively.

Referring next to FIG. 12B, a method 1200B is generally similar to the method 1200A, but a CU 172 105 transmits a first CU-to-DU message to a DU 174 to release MRB irrespective of the DRB configuration. The differences between the methods of FIG. 12A and FIG. 12B are discussed in more detail below.

After determining to release the MRB for the UE 102 at block 1206, the flow continues to block 1210. At block 1210, in response to the determination and irrespective of whether the UE 102 is configured with a DRB, the CU 172 causes the DU 174 to release configuration parameters associated with the MRB for the UE 102 by transmitting a first CU-to-DU message to the DU 174. Then, at block 1208, the CU 172 determines whether the UE 102 is configured or is not configured with DRB. If the UE 102 is configured with a DRB, then the flow continues to block 1213 where the procedure ends. If the UE 102 is not configured with a DRB, the flow proceeds to block 1214. At block 1214, in response to the determination, the CU 172 causes the DU 174 to release a UE context of the UE 102 by transmitting a second CU-to-DU message to the DU 174 (e.g., event 624 of FIG. 6). In some implementations, the flow continues to block 1216 from block 1214. At block 1216, the CU 172 receives from the DU 174 a second DU-to-CU message in response to the second CU-to-DU message (e.g., event 624 of FIG. 628).

The following list of examples reflects a variety of the implementations explicitly contemplated by the present disclosure:

Example 1. A method, performed by a user equipment (UE), of managing multicast and/or broadcast services (MBS) communications after a state transition, the method comprising: receiving MBS data from a radio access network (RAN) using MBS configuration parameters while the UE is in a connected state with the RAN; transitioning from the connected state to an idle state or an inactive state; and while the UE is in the idle state or the inactive state, and based on whether the MBS configuration parameters are for receiving a broadcast MBS session or a non-broadcast MBS session, either continuing or not continuing, respectively, to receive MBS data using the MBS configuration parameters.

Example 2. The method of example 1, wherein the transitioning includes transitioning from the connected state to the idle state.

Example 3. The method of example 2, wherein the method comprises: when the MBS configuration parameters are for receiving a broadcast MBS session, retaining the MBS configuration parameters and continuing to receive MBS data using the MBS configuration parameters; and when the MBS configuration parameters are for receiving a non-broadcast MBS session, releasing the MBS configuration parameters.

Example 4. The method of example 1, wherein the transitioning includes transitioning from the connected state to the inactive state.

Example 5. The method of example 4, wherein the method comprises: when the MBS configuration parameters are for receiving a broadcast MBS session, retaining the MBS configuration parameters and continuing to receive MBS data using the MBS configuration parameters; and when the MBS configuration parameters are for receiving a non-broadcast MBS session, retaining the MBS configuration parameters and suspending use of the MBS configuration parameters.

Example 6. The method of example 1, further comprising: receiving a radio resource control (RRC) release message from the RAN, wherein the transitioning is in response to the RRC release message.

Example 7. The method of example 6, wherein: when the RRC release message indicates a transition to the idle state, (i) the transitioning includes transitioning to the idle state, and (ii) the method comprises retaining or releasing the MBS configuration parameters based on whether the MBS configuration parameters or for receiving a broadcast MBS session or a non-broadcast MBS session, respectively.

Example 8. The method of example 6, wherein: when the RRC release message indicates a transition to the inactive state, (i) the transitioning includes transitioning to the inactive state, and (ii) the method comprises retaining the MBS configuration parameters and either continuing or not continuing to use the MBS configuration parameters to receive MBS data based on whether the MBS configuration parameters or for receiving a broadcast MBS session or a non-broadcast MBS session, respectively.

Example 9. The method of any one of examples 1-8, comprising: not continuing to receive MBS data using the MBS configuration parameters when the MBS configuration parameters are for receiving a multicast MBS session.

Example 10. The method of any one of examples 1-8, comprising: not continuing to receive MBS data using the MBS configuration parameters when the MBS configuration parameters are for receiving a unicast MBS session.

Example 11. A method, performed by a user equipment (UE), of managing multicast and/or broadcast services (MBS) communications after a state transition, the method comprising: receiving MBS data from a radio access network (RAN) via a first MBS radio bearer (MRB) and/or a second MRB while the UE is in a connected state with the RAN; receiving an RRC release message from the RAN while the UE is in the connected state; in response to the RRC release message, (i) transitioning from the connected state to an idle state or an inactive state, and (ii) releasing or suspending the first MRB; and receiving further MBS data from the RAN via the second MRB while the UE is in the idle state or the inactive RRC state.

Example 12. The method of example 11, comprising: in response to the RRC release message, (i) transitioning from the connected state to the idle state, and (ii) releasing the first MRB, wherein receiving the further MBS data via the second MRB occurs while the UE is in the idle state.

Example 13. The method of example 11, comprising: in response to the RRC release message, (i) transitioning from the connected state to the inactive state, and (ii) suspending the first MRB, wherein receiving the further MBS data via the second MRB occurs while the UE is in the inactive state.

Example 14. A method, performed by a user equipment (UE), of managing multicast and/or broadcast services (MBS) communications after a state transition, the method comprising: receiving MBS data from a radio access network (RAN) using MBS configuration parameters while the UE is in an inactive state and while retaining unicast configuration parameters; transitioning from the inactive state to an idle state; in response to the transitioning, releasing the unicast configuration parameters; and receiving further MBS data from the RAN using the MBS configuration parameters while the UE is in the idle state.

Example 15. The method of example 14, wherein receiving the further MBS data using the MBS configuration parameters when the MBS configuration parameters are for receiving a broadcast MBS session rather than a non-broadcast MBS session.

Example 16. The method of example 15, wherein receiving the further MBS data using the MBS configuration parameters when the MBS configuration parameters are for receiving a broadcast MBS session rather than a multicast or unicast MBS session.

Example 17. A user equipment (UE) configured to perform the method of any one of examples 1-16.

Example 18. A method, performed by a radio access network (RAN) node, of managing multicast and/or broadcast services (MBS) communications, the method comprising: transmitting MBS data to a user equipment (UE) via an MBS radio bearer (MRB); determining to release the MRB for the UE; and after the determining, and based on whether the UE is or is not configured with a data radio bearer (DRB), either not transmitting or transmitting, respectively, a radio resource control (RRC) release message to the UE.

Example 19. The method of example 18, comprising: when the UE is configured with a DRB, causing the UE to release the MRB by transmitting an RRC reconfiguration message to the UE; and when the UE is not configured with a DRB, causing the UE to release the MRB by transmitting the RRC release message to the UE.

Example 20. The method of example 18, further comprising: causing the UE to release the MRB by transmitting an RRC reconfiguration message to the UE irrespective of whether the UE is configured with a DRB.

Example 21. The method of any one of examples 18-20, wherein the RAN node is a base station of the RAN.

Example 22. A radio access network (RAN) node configured to perform the method of any one of examples 18-21.

Example 23. A method, performed by a central unit (CU) of a base station, of managing multicast and/or broadcast services (MBS) communications, the method comprising: transmitting MBS data to a user equipment (UE) via a distributed unit (DU) of the base station and an MBS radio bearer (MRB); determining to release the MRB for the UE; and after the determining, and based on whether the UE is or is not configured with a data radio bearer (DRB), either not transmitting or transmitting, respectively, a first CU-to-DU message to the DU indicating that the DU is to release a UE context of the UE.

Example 24. The method of example 23, comprising: when the UE is configured with a DRB, causing the DU to release configuration parameters associated with the MRB by transmitting a second CU-to-DU message to the DU; and when the UE is not configured with a DRB, causing the DU to release the UE context of the UE by transmitting the first CU-to-DU message to the DU.

Example 25. The method of example 24, further comprising: when the UE is not configured with a DRB and after causing the DU to release the UE context of the UE, receiving from the DU a first DU-to-CU message; and when the UE is configured with a DRB and after causing the DU to release the configuration parameters, receiving from the DU a second DU-to-CU message.

Example 26. The method of example 25, wherein: the first CU-to-DU message is a UE context release command request message; the first DU-to-CU message is a UE context release complete message; the second CU-to-DU message is a UE context modification request message; and the second DU-to-CU message is a UE context modification response message.

Example 27. The method of example 25, wherein: the first CU-to-DU message is a UE context release command request message; the first DU-to-CU message is a UE context release complete message; the second CU-to-DU message is a UE context setup request message; and the second DU-to-CU message is a UE context setup response message.

Example 28. The method of example 23, comprising: causing the DU to release configuration parameters associated with the MRB by transmitting a second CU-to-DU message to the DU, irrespective of whether the UE is configured with a DRB; and when the UE is not configured with a DRB, causing the DU to release the UE context of the UE by transmitting the first CU-to-DU message to the DU.

Example 29. The method of example 28, further comprising: when the UE is not configured with a DRB and after causing the DU to release the UE context of the UE, receiving from the DU a first DU-to-CU message.

Example 30. The method of example 29, wherein the first CU-to-DU message is a UE context release command message and the first DU-to-CU message is a UE context release complete message.

Example 31. The method of any one of examples 23-30, further comprising: before transmitting the MBS data, configuring the MRB with the DU for the UE.

Example 32. A central unit (CU) of a base station, the CU being configured to perform the method of any one of examples 23-31.

The following additional considerations apply to the foregoing discussion.

In some implementations, “message” is used and can be replaced by “information clement (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A or 102B) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method, performed by a user equipment (UE), of managing multicast and/or broadcast services (MBS) communications after a state transition, the method comprising:
receiving MBS data from a radio access network (RAN) using MBS configuration parameters while the UE is in a connected state with the RAN;
transitioning from the connected state to an idle state; and
while the UE is in the idle state, and based on whether the MBS configuration parameters are for receiving a broadcast MBS session or a non-broadcast MBS session, either continuing or not continuing, respectively, to receive MBS data using the MBS configuration parameters,
wherein the method comprises
when the MBS configuration parameters are for receiving a broadcast MBS session, retaining the MBS configuration parameters and continuing to receive MBS data using the MBS configuration parameters, and
when the MBS configuration parameters are for receiving a non-broadcast MBS session, releasing the MBS configuration parameters.

2. The method of claim 1, comprising:
not continuing to receive MBS data using the MBS configuration parameters when the MBS configuration parameters are for receiving a multicast MBS session.

3. The method of claim 1, comprising:
not continuing to receive MBS data using the MBS configuration parameters when the MBS configuration parameters are for receiving a unicast MBS session.

4. A method, performed by a user equipment (UE), of managing multicast and/or broadcast services (MBS) communications after a state transition, the method comprising:
receiving MBS data from a radio access network (RAN) using MBS configuration parameters while the UE is in a connected state with the RAN;
transitioning from the connected state to an inactive state; and
while the UE is in the inactive state, and based on whether the MBS configuration parameters are for receiving a broadcast MBS session or a non-broadcast MBS session, either continuing or not continuing, respectively, to receive MBS data using the MBS configuration parameters,
wherein the method comprises
when the MBS configuration parameters are for receiving a broadcast MBS session, retaining the MBS configuration parameters and continuing to receive MBS data using the MBS configuration parameters, and
when the MBS configuration parameters are for receiving a non-broadcast MBS session, retaining the MBS configuration parameters and suspending use of the MBS configuration parameters.

5. The method of claim 4, comprising:
not continuing to receive MBS data using the MBS configuration parameters when the MBS configuration parameters are for receiving a multicast MBS session.

6. The method of claim 4, comprising:
not continuing to receive MBS data using the MBS configuration parameters when the MBS configuration parameters are for receiving a unicast MBS session.

7. A method, performed by a user equipment (UE), of managing multicast and/or broadcast services (MBS) communications after a state transition, the method comprising:
receiving MBS data from a radio access network (RAN) using MBS configuration parameters while the UE is in a connected state with the RAN;
receiving a radio resource control (RRC) release message from the RAN;
transitioning from the connected state to an idle state or an inactive state in response to the RRC release message; and
while the UE is in the idle state or the inactive state, and based on whether the MBS configuration parameters are for receiving a broadcast MBS session or a non-broadcast MBS session, either continuing or not continuing, respectively, to receive MBS data using the MBS configuration parameters,
wherein when the RRC release message indicates a transition to the idle state, (i) the transitioning includes transitioning to the idle state, and (ii) the method comprises retaining or releasing the MBS configuration parameters based on whether the MBS configuration parameters are for receiving a broadcast MBS session or a non-broadcast MBS session, respectively.

8. The method of claim 7, wherein:
when the RRC release message indicates a transition to the inactive state, (i) the transitioning includes transitioning to the inactive state, and (ii) the method comprises retaining the MBS configuration parameters and either continuing or not continuing to use the MBS configuration parameters to receive MBS data based on whether the MBS configuration parameters are for receiving a broadcast MBS session or a non-broadcast MBS session, respectively.

9. The method of claim 7, comprising:
not continuing to receive MBS data using the MBS configuration parameters when the MBS configuration parameters are for receiving a multicast MBS session.

10. The method of claim 7, comprising:
not continuing to receive MBS data using the MBS configuration parameters when the MBS configuration parameters are for receiving a unicast MBS session.

11.-26. (canceled)

27. A user equipment (UE) comprising processing hardware and configured to:
receive multicast and/or broadcast services (MBS) data from a radio access network (RAN) using MBS configuration parameters while the UE is in a connected state with the RAN;
transition from the connected state to an idle state; and
while the UE is in the idle state, and based on whether the MBS configuration parameters are for receiving a broadcast MBS session or a non-broadcast MBS session, either continue or do not continue, respectively, to receive MBS data using the MBS configuration parameters,
wherein the UE is configured to
when the MBS configuration parameters are for receiving a broadcast MBS session, retain the MBS configuration parameters and continue to receive MBS data using the MBS configuration parameters, and
when the MBS configuration parameters are for receiving a non-broadcast MBS session, release the MBS configuration parameters.

28. The UE of claim 27, wherein the UE is configured to:
not continue to receive MBS data using the MBS configuration parameters when the MBS configuration parameters are for receiving a multicast MBS session.

29. The UE of claim 27, wherein the UE is configured to:
not continue to receive MBS data using the MBS configuration parameters when the MBS configuration parameters are for receiving a unicast MBS session.

30. A user equipment (UE) comprising processing hardware and configured to:
receive multicast and/or broadcast services (MBS) data from a radio access network (RAN) using MBS configuration parameters while the UE is in a connected state with the RAN;
transition from the connected state to an inactive state; and
while the UE is in the inactive state, and based on whether the MBS configuration parameters are for receiving a broadcast MBS session or a non-broadcast MBS session, either continue or do not continue, respectively, to receive MBS data using the MBS configuration parameters,
wherein the UE is configured to
when the MBS configuration parameters are for receiving a broadcast MBS session, retain the MBS configuration parameters and continue to receive MBS data using the MBS configuration parameters, and
when the MBS configuration parameters are for receiving a non-broadcast MBS session, retain the MBS configuration parameters and suspend use of the MBS configuration parameters.

31. The UE of claim 30, wherein the UE is configured to:
not continue to receive MBS data using the MBS configuration parameters when the MBS configuration parameters are for receiving a multicast MBS session.

32. The UE of claim 30, wherein the UE is configured to:
not continue to receive MBS data using the MBS configuration parameters when the MBS configuration parameters are for receiving a unicast MBS session.

33. A user equipment (UE) comprising processing hardware and configured to:
receive multicast and/or broadcast services (MBS) data from a radio access network (RAN) using MBS configuration parameters while the UE is in a connected state with the RAN;
receive a radio resource control (RRC) release message from the RAN;
transition from the connected state to an idle state or an inactive state in response to the RRC release message; and
while the UE is in the idle state or the inactive state, and based on whether the MBS configuration parameters are for receiving a broadcast MBS session or a non-broadcast MBS session, either continue or do not continue, respectively, to receive MBS data using the MBS configuration parameters,
wherein when the RRC release message indicates a transition to the idle state, (i) the transitioning includes transitioning to the idle state, and (ii) the UE is configured to retain or release the MBS configuration parameters based on whether the MBS configuration parameters are for receiving a broadcast MBS session or a non-broadcast MBS session, respectively.

34. The UE of claim 33, wherein:
when the RRC release message indicates a transition to the inactive state, (i) the transitioning includes transitioning to the inactive state, and (ii) the UE is configured to retain the MBS configuration parameters and either continue or not continue to use the MBS configuration parameters to receive MBS data based on whether the MBS configuration parameters are for receiving a broadcast MBS session or a non-broadcast MBS session, respectively.

35. The UE of claim 33, wherein the UE is configured to:
not continue to receive MBS data using the MBS configuration parameters when the MBS configuration parameters are for receiving a multicast MBS session.

36. The UE of claim 33, wherein the UE is configured to:
not continue to receive MBS data using the MBS configuration parameters when the MBS configuration parameters are for receiving a unicast MBS session.
